(19) United States
(12) Patent Application Publication
(10) Pub. No.: US 2019/0156678 A1
(43) Pub. Date: May 23, 2019

(54) Systems and methods for coordinated passenger offloading of autonomous vehicles at large scale parking destinations

(71) Applicant: Tony Mitchell Cole, Enterprise, FL (US)

(72) Inventor: Tony Mitchell Cole, Enterprise, FL (US)

(21) Appl. No.: 16/350,476

(22) Filed: Nov. 20, 2018

Related U.S. Application Data
(60) Provisional application No. 62/588,450, filed on Nov. 20, 2017.

(51) Int. Cl. G08G 1/00; G05D 1/00; G05D 1/02; G08G 1/16; G06K 9/00; G08G 1/04

(52) U.S. Cl. CPC G08G 1/20; G05D 1/0088; G05D 1/0246; G08G 1/166; G05D 2201/0213; G06K 9/00785; G08G 1/04; G05D 1/0276; G08G 1/164

(57) ABSTRACT

A system includes multiple cameras directed to capture images or video of a passenger offloading area associated with a facility, where the passenger offloading area comprises multiple offloading areas that enable multiple autonomous vehicles to offload vehicle occupants. The system receives images or video, from the multiple cameras, of the passenger offloading area, and analyzes the images or video to identify autonomous vehicles of the multiple autonomous vehicles that have completed passenger offloading and have departed respective offloading areas. The system instructs, based on the image or video analysis, the multiple autonomous vehicles to transit through the passenger offloading area in a coordinated manner, including stopping at a selected one of the multiple passenger offloading areas, to offload the vehicle occupants. The system instructs each of the multiple autonomous vehicles to drive to a destination outside of the passenger offloading area subsequent to transiting through the passenger offloading area.

### CROSS-REFERENCE TO RELATED APPLICATION

This application claims priority under 35 U.S.C. § 119, based on U.S. Provisional Application No. 62/588,450, filed Nov. 20, 2017, the disclosure of which is incorporated by reference herein.

### BACKGROUND

Autonomous vehicles employ various sensors for sensing the driving environment around the autonomous vehicles, and use an advanced control system for navigating, without human operator input, based on the sensed driving environment. The various sensors employed by autonomous vehicles may include, for example, radar, lasers, Global Positioning Systems (GPS), image/video processing systems, and odometers. The advanced control systems interpret the sensor information provided by the various sensors to detect aspects of the driving environment and to identify a navigation route for the vehicles. The sensors, in conjunction with the control systems, are used to understand the world around each vehicle, including the position of surrounding vehicles, the status of any nearby infrastructure, any traffic concerns, and any potential safety hazards. Autonomous vehicles are predicted to reduce traffic accidents and to improve the speed and flow of traffic on vehicle roadways.

### BRIEF DESCRIPTION OF THE DRAWINGS

FIG. 1A illustrates an exemplary environment in which a system is implemented that coordinates and facilitates the passenger offloading and parking of autonomous vehicles at a large-scale parking facility or at a location that requires passenger offloading on a large scale;

FIG. 1B depicts one exemplary implementation of the network environment shown in FIG. 1A;

FIG. 2 depicts an example of the autonomous vehicle passenger offloading area of FIG. 1A in which the offloading area includes a turning lane, a thru lane, and multiple offloading pull-off areas;

FIG. 3A depicts one example of the placement of cameras relative to passenger offloading pull-off areas within the passenger offloading area of 2;

FIG. 3B depicts one exemplary implementation of the use of offloading stations to identify when passengers have completely offloaded from each autonomous vehicle at an offloading pull-off area;

FIG. 4 is a diagram that depicts exemplary components of an autonomous vehicle;

FIG. 5 is a diagram that depicts an exemplary, implementation of the autonomous vehicle offloading database of FIG. 1A;

FIG. 6 is a flowchart that illustrates an exemplary process for asserting control over an autonomous vehicle as the autonomous vehicle approaches the passenger offloading area, depicted in FIG. 2, prior to parking in a parking facility;

FIG. 7 depicts an exemplary touch screen user interface contained within an autonomous vehicle;

FIG. 8 depicts a simplified example of the parking offloading area, shown in FIG. 2, which includes three offloading pull-off areas;

FIG. 9A depicts one example of a group of passengers offloading from an autonomous vehicle at an offloading pull-off area in the parking offloading area shown in FIG. 2;

FIG. 9B depicts an exemplary touch screen display of an offloading station that enables passengers to indicate that they are fully offloaded from their vehicle;

FIG. 9C depicts another example of a group of passengers offloading from an autonomous vehicle at an offloading pull-off area in the parking offloading area of FIG. 2;

FIG. 10 is a flowchart that illustrates an exemplary process for controlling, in a coordinated manner, the movement of autonomous vehicles through a parking offloading area and to a parking facility for vehicle parking;

FIGS. 11A and 11B are flowcharts that illustrate an exemplary implementation of block 1010 of FIG. 10 involving the determination of the current passenger offload status of passengers offloading from autonomous vehicles at an offloading position of a passenger offloading area;

FIG. 12 depicts multiple counters associated with respective timing bins, where each timing bin corresponds to a final time of a passenger offloading timer t_{Offx};

FIG. 13A depicts a two-dimensional representation of a histogram of number of vehicle offloads vs. passenger offloading time (t_{Offx});

FIG. 13B further depicts a two-dimensional representation of the relative frequency distribution of passenger offloading time (t_{Offx});

FIG. 13C depicts probability values associated with the relative frequency distribution curve of FIG. 13B;

FIGS. 14A-14C are flowcharts that illustrate an exemplary process for the centralized control of the movement of an autonomous vehicle, through the passenger offloading area depicted in FIG. 2, in coordination with the movement of other autonomous vehicles also moving through the offloading area;

FIGS. 15A and 15B depict blocks, that may be optionally used within the exemplary process of FIGS. 14A-14C, which use probability values for determining a first offloading position that is predicted to have the highest probability of emptying of an autonomous vehicle; and

FIG. 16 depicts an example relative frequency distribution curve for purposes of illustrating the calculation of the probability of offloading for vehicles at offloading positions in the optional blocks of FIGS. 15A and 15B.

### DETAILED DESCRIPTION OF THE PREFERRED EMBODIMENTS

The following detailed description refers to the accompanying drawings. The same reference numbers in different drawings may identify the same or similar elements. The following detailed description does not limit the invention, which is defined by the claims.

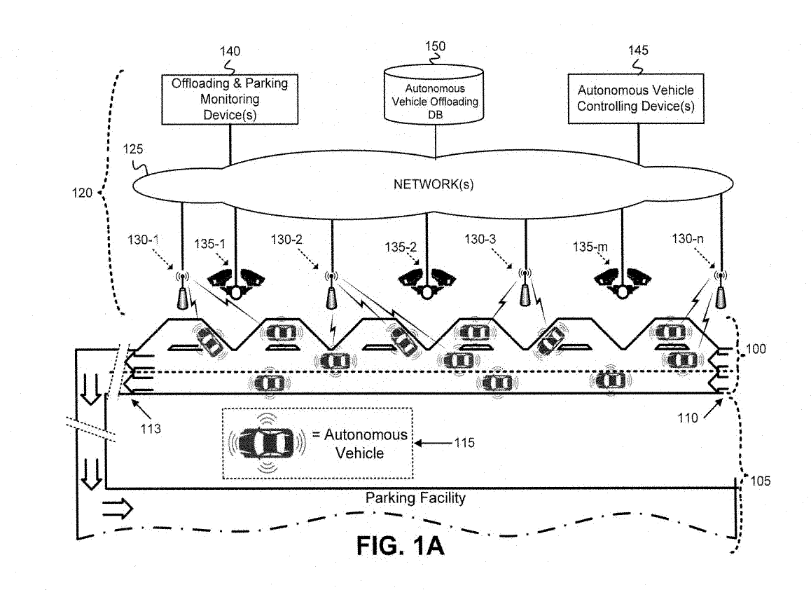

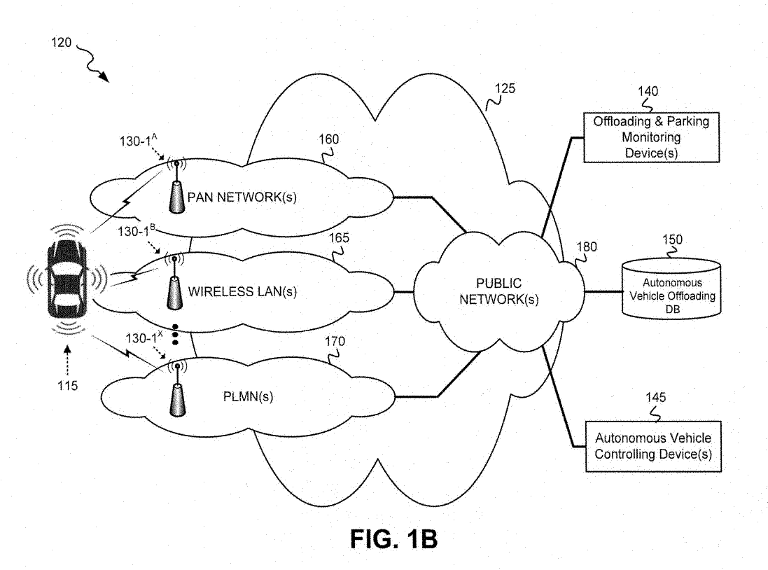

FIG. 1A illustrates an exemplary environment in which a system is implemented that coordinates and facilitates the passenger offloading and parking of autonomous vehicles at a location associated with a large-scale parking facility, or at a location that requires passenger offloading on a large-scale or at a high volume. The large-scale parking facility, and/or the location that requires passenger offloading of autonomous vehicles on a large-scale or at a high volume, may involve large numbers of autonomous vehicles arriving and offloading passengers within relatively short periods of time. For example, a theme park, a stadium or arena hosting an event, a regional fair or festival, or similar types of locations or events may involve large numbers of vehicles arriving at a same time so that vehicle passengers may disembark from the vehicles to proceed to the event or location.

As shown in FIG. 1A, the environment may include an autonomous vehicle passenger offloading area 100, a parking facility 105, a network environment 120 that is associated with the passenger offloading area 100, and autonomous vehicles 115 (referred to herein as “vehicle 115,” “vehicles 115,” “autonomous vehicle 115,” or “autonomous vehicles 115”). The autonomous vehicles 115 each include a vehicle that further includes vehicle sensors and an autonomous driving control unit that enables the vehicle 115 to drive autonomously without necessarily requiring driving vigilance on the part of the vehicle driver or passenger(s). Autonomous vehicles 115 may be 100% autonomous, or may have the capability for the vehicle driver to take control of the vehicle 115 and exercise driving control using, for example, a steering wheel, vehicle acceleration pedal, vehicle brake pedal, etc. Each autonomous vehicle 115 includes at least one wireless communication interface for communicating via one or more wireless networks. In some implementations, each vehicle 115 may include multiple different types of wireless communication interfaces, including, for example, a personal area network (PAN) (e.g., BLUETOOTH), a wireless local area network (LAN) (e.g., Wi-Fi), and/or a cellular network communication interface.

The parking facility 105 of the environment of FIG. 1A may include any type of facility that permits the parking of vehicles, including autonomous vehicles 115, such as a parking lot, a parking structure, or a parking garage. In one implementation, the parking facility 105 may include a large-scale parking facility associated with a location or facility having an activity, event, entity, or building(s) that may need many parking spaces to provide adequate parking for the parking of the vehicles associated with numerous employees, guests, invitees, licensees, etc. The location or facility having the activity, event, entity, or building may include the passenger offloading area 100 to enable numerous employees, guests, invitees, licensees, etc. to offload from autonomous vehicles 115 in an efficient and safe manner. The large-scale parking facility may be associated with, for example, a theme park, a shopping mall, a university, a stadium or arena, and/or a mass transit station (e.g., a train station, a subway station). In some circumstances, the parking facility 105 may not exist in association with the location or facility (e.g., theme park, shopping mall, stadium) having the activity, event, entity, or building. In such circumstances, the passenger offloading area 100 may enable the offloading of vehicle passengers/occupants at the location or facility, and the offloaded autonomous vehicles may then exit the location or facility to proceed to another destination (e.g., to park elsewhere, to return to ridesharing, or to pick up a next passenger at another location). In these circumstances, the location or facility may not have its own parking facility 105, but may only include a passenger offloading area 100 for offloading autonomous vehicle passengers or occupants.

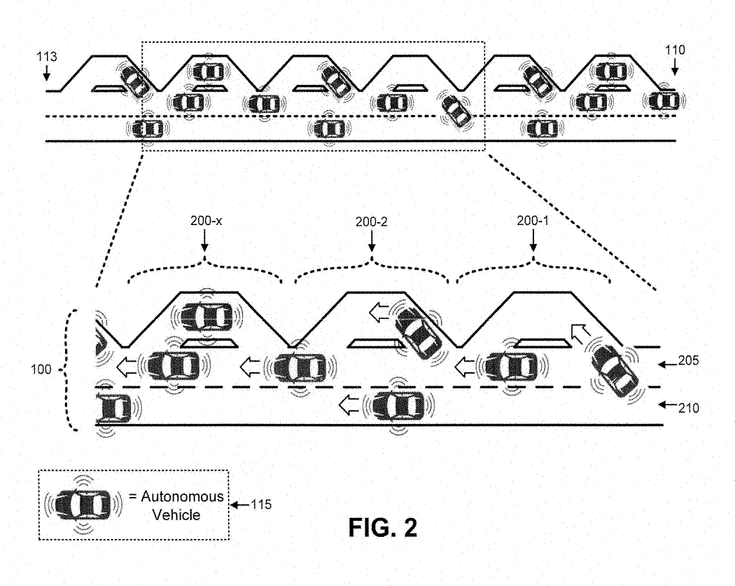

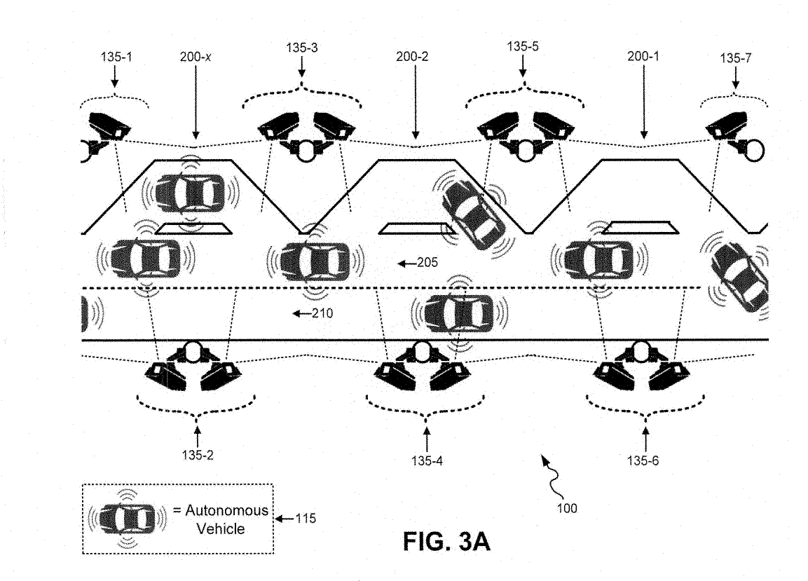

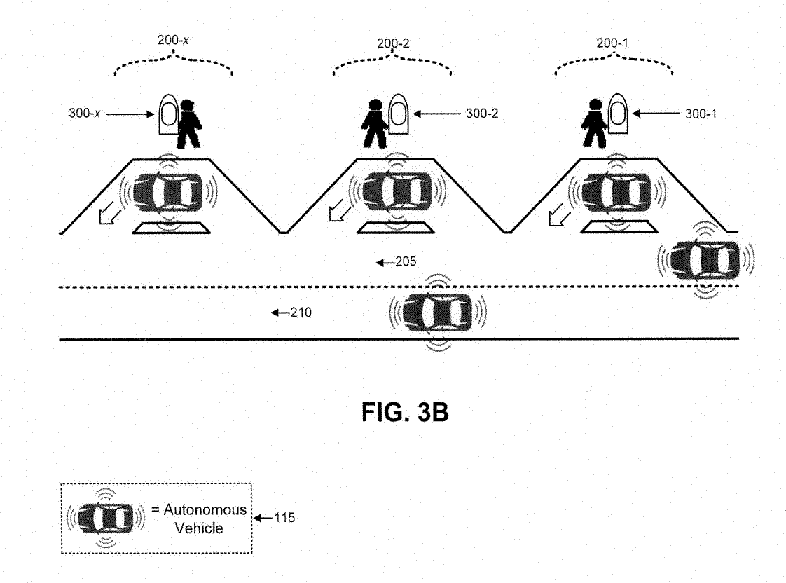

As shown in the exemplary environment of FIG. 1A, autonomous vehicle passenger offloading area 100 (referred to herein as “passenger offloading area 100” or “offloading area 100”) may include a drive-through roadway that enables autonomous vehicles 115 to offload passengers. Autonomous vehicle passenger offloading area 100 permits the autonomous vehicles 115 to drive from an entrance 110 of the offloading area 110 through to an exit 113 of the offloading area 100 and on to the parking facility 105 and/or to exit the location of the event, entity, or building, while stopping at one of multiple passenger offloading locations (described in further detail below with respect to FIGS. 2, 3A, and 3B below) to offload passengers, before the autonomous vehicles 115 are automatically directed to park within the parking facility 105, or are automatically directed to return to another location or destination (e.g., a vehicle ride sharing facility unassociated with parking facility 105). The autonomous vehicles 115, once parked in parking facility 105, may await the return of the passengers before autonomously driving to a pick-up location to pick up the passengers.

Network environment 120 may include a network(s) 125, one or more wireless stations 130-1 through 130-n (referred to herein as “wireless station 130” or “wireless stations 130”), multiple cameras 135-1 through 135-m (referred to herein as “camera 135” or “cameras 135”), an offloading and parking monitoring device(s) 140, an autonomous vehicle controlling device(s) 145, and an autonomous vehicle offloading database (DB) 150.

Network(s) 125 includes one or more networks that connect to the one or more wireless stations 130-1 through 130-n either via wired or wireless connections. Network(s) 125 may include, for example, a public land mobile network(s) (PLMN(s)), a satellite mobile network(s), a telecommunications network(s) (e.g., a Public Switched Telephone Network(s) (PSTN(s)), a wired and/or wireless local area network(s) (LAN), a wired and/or wireless wide area network(s) (WAN(s)), a metropolitan area network(s) (MAN(s)), one or more wireless personal area networks (PANs), an intranet(s), the Internet, and/or a cable network(s) (e.g., optical fiber cable network(s)). Wireless stations 130 may be integral components of network(s) 125 and/or may be external wireless stations that connect to network(s) 125.

In the case of network(s) 125 including a PLMN, wireless stations 130 may include one or more mobile base stations (e.g., evolved Node Bs (eNBs)) that are components of the PLMN. In the case of network(s) 125 including a LAN or WAN connected to the Internet, the wireless stations 130 may include local LAN wireless transceivers (e.g., Wi-Fi transceiver stations) that enable autonomous vehicles 115 to connect to the LAN or WAN. Each of the wireless stations 130-1 through 130-n includes at least one antenna or antenna array, and at least one associated transceiver unit, that can transmit wirelessly to autonomous vehicles 115, and receive wirelessly from autonomous vehicles 115.

The multiple cameras 135-1 through 135-m may each include a camera (e.g., still picture, or video camera) geographically located so as to have a particular view of passenger offloading area 100. The multiple cameras 135-1 through 135-m may be disposed at various locations, and at various heights (i.e., height above the ground), within passenger offloading area 100 to have a sufficient aggregate view of the current locations of every autonomous vehicle 115 within the passenger offloading area 100, and the current status (e.g., occupied or empty) of each offloading position and queuing position (described in further detail below with respect to FIGS. 2, 3A, and 3B below) within the passenger offloading area 100.

Offloading and parking monitoring device(s) 140 (referred to herein as “device(s) 140”) includes one or more network devices that keep track of the position, movement, and passenger offloading status (e.g., offloading time, number of offloaded passengers, etc.) of each autonomous vehicle 115 within passenger offloading area 100 (and possibly parking facility 105), and keep track of the current status of each offloading position (e.g., occupied with vehicle, or no vehicle) and queuing position within the passenger offloading area 100.

Autonomous vehicle controlling node(s) 145 (referred to herein as “device(s) 145”) includes one or more network devices that receive data from device(s) 140 regarding the position, movement, and passenger offloading status of each autonomous vehicle 115 within the passenger offloading area 100 and parking facility 105, and issues instructions to control the position and movement of each autonomous vehicle 115, in a coordinated fashion with every other vehicle 115 within passenger offloading area 100, until each vehicle 115 departs from passenger offloading area 100 (and possibly parking facility 105). In some implementations, the different functions performed by device(s) 140 and device(s) 145 may be performed by a single network device, or by a same group of network devices.

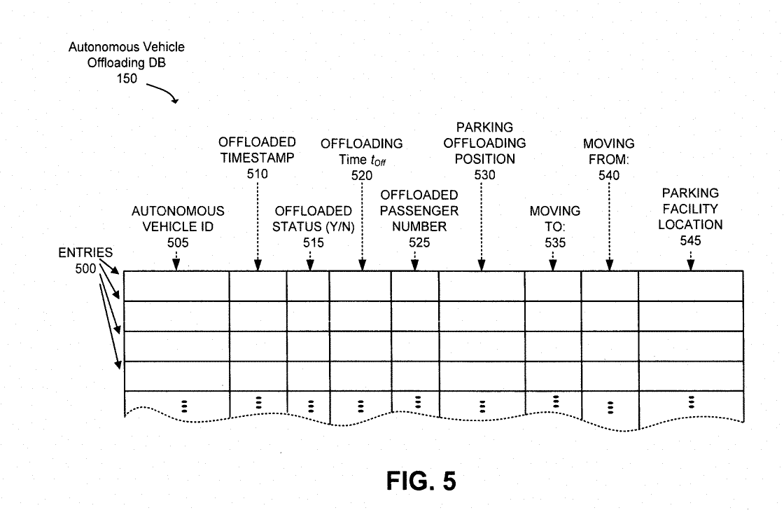

Autonomous vehicle offloading DB 150 includes one or more network devices that include memory that stores a database or data structure. The data structure may store data related to autonomous vehicles 115 that have entered passenger offloading area 100 and/or parking facility 105. The data may include, for example, vehicle identifiers (IDs), vehicle passenger offloading status, vehicle parking facility parked location, and vehicle movement location and status. One exemplary data structure that may be stored in DB 150 is described with respect to FIG. 5 below.

FIG. 1B depicts an exemplary implementation of network environment 120 shown in FIG. 1A. In the exemplary implementation shown, network(s) 125 of network environment 120 may include at least one wireless personal area network(s) (PAN) 160, at least one wireless LAN(s) 165, and/or at least one PLMN(s) 170. PAN 160, wireless LAN 165, and PLMN(s) 170 may connect to a public network 180.

Wireless PAN(s) 160 includes any type of personal area network carried over a low power, short range wireless protocol such as, for example, Bluetooth™, Insteon, Infrared Data Association (IrDA), wireless Universal Serial Bus (USB), Z-Wave, ZigBee, and/or Body Area Network (BAN). Wireless PAN(s) 210 may include a single PAN between each autonomous vehicle 115 and a wireless station 130 for transmitting data between them. The reach of each wireless PAN(s) 160 may vary from a few meters to tens of meters, depending on the specific short range wireless protocol used and the range needed to reach a closest wireless station 130.

Wireless LAN 165 includes one or more wireless LANs of any type, such as, for example, a Wi-Fi network that operates according to the IEEE 802.11 standard. PLMN(s) 170 may include one or more PLMNs and/or one or more satellite networks. The one or more PLMNs may each include, for example, a Code Division Multiple Access (CDMA) 2000 PLMN, a Global System for Mobile Communications (GSM) PLMN, a Long Term Evolution (LTE) PLMN (e.g., such as a fourth or fifth-generation (4G or 5G) LTE network), and/or other types of PLMNs. Public network 180 may include any type of network that is available to the general public such as, for example, the Internet. Alternatively, in some implementations, network 180 may include a private network (e.g., a wired LAN) that has a restricted and controlled access, and which itself may connect to a public network, such as, for example, the Internet.

As shown in FIG. 1B, offloading and parking monitoring device(s) 140, autonomous vehicle controlling device(s) 145, and autonomous vehicle offloading DB 150 may connect to public network(s) 180. Device(s) 140 and 150 may, for example, communicate with an autonomous vehicle 115 via any of the following: a) wireless station 130-1^{A}, PAN network(s) 160, and public network(s) 180; b) wireless station 130-1^{B}, wireless LAN(s) 165, and public network(s) 180; and/or c) wireless station 130-1^{X}, PLMN(s) 170, and public network(s) 180.

The configuration of the components of the network environment 120 depicted in FIGS. 1A and 1B is for illustrative purposes only, and other configurations may be implemented. Therefore, network environment 120 may include additional, fewer and/or different components, that may be configured differently, than depicted in FIGS. 1A and 1B.

FIG. 2 depicts an example of autonomous vehicle passenger offloading area 100 in which offloading area 100 includes a turning lane 205, a thru lane 210, and multiple offloading pull-off areas 200-1 through 200-x (where x is greater than or equal to two). The turning lane 205 permits autonomous vehicles 115 to drive through the passenger offloading area 100, while enabling the autonomous vehicles 115 to turn into one of the multiple offloading pull-off areas 200-1 through 200-x. The thru lane 210 permits autonomous vehicles to drive from the entrance 110 to the offloading area 100 to the exit 113 of the offloading area 100 without encountering autonomous vehicles 115 turning into the offloading pull-off areas 200 or pulling out of pull-off areas 200. Autonomous vehicles 115 may enter the entrance 110 to the offloading area 100 carrying one or more passengers who desire to offload from the vehicles 115. During transit of turning lane 205 and/or thru lane 210, each autonomous vehicle 115 is instructed, by device(s) 145, to turn into one of the offloading pull-off areas 200 and temporarily park to enable the one or more passengers riding in the vehicle 115 to disembark from the vehicle 115. Once all of the passengers have disembarked from a vehicle 115, the vehicle 115 is directed, by device(s) 145, to drive out of the offloading pull-off area 200, across the turning lane 205, and into the thru lane 210 for transit via the thru lane 210 to the parking facility 105, or to another destination. Device(s) 145 coordinates the movement of autonomous vehicles 115 through turning lane 205, thru lane 210, and offloading pull-off areas 200 of passenger offloading area 100, as described in further detail below, to maximize vehicle, passenger, and pedestrian safety and to maximize the passenger offloading rate based on passenger offloading and vehicle movement information provided by device(s) 140.

FIG. 3A depicts one example of the placement of cameras 135 relative to offloading pull-off areas 200-1 through 200-x within passenger offloading area 100. As shown, cameras 135 are strategically placed within passenger offloading area 100 to maintain sufficient viewing coverage of the entire passenger offloading area 100, including viewing of the movement of autonomous vehicles 115 anywhere on turn lane 205, and anywhere on thru lane 210, and viewing of the movement of vehicles within offloading pull-off areas 200. The cameras 135 also are placed to enable the viewing of the offloading of passengers from autonomous vehicles 115 temporarily parked within each of the multiple offloading pull-off areas 200-1 through 200-x. Images and/or video taken by each of cameras 135 may be analyzed, using image/video processing techniques, to identify the location, and movement, of each autonomous vehicle 115 within passenger offloading area 100. The images and/or video may also be analyzed, using image/video processing techniques, to determine how many passengers are offloading from each autonomous vehicle 115 at each offloading pull-off area 200, how long it takes to offload each autonomous vehicle 115 at each offloading pull-off area 200, and/or when passenger offloading at each autonomous vehicle 115 is completed.

FIG. 3B depicts one exemplary implementation of the use of offloading stations to identify when passengers have completely offloaded from the autonomous vehicles 115 at the offloading pull-off areas 200. In the embodiment shown in FIG. 3B, each offloading pull-off area 200 includes a respective offloading station 300. For example, as shown, offloading pull-off area 200-1 includes an offloading station 300-1, offloading pull-off area 200-2 includes an offloading station 300-2, and offloading pull-off area 200-x includes an offloading station 300-x. Each offloading station 300 further includes a wired or wireless device into which a passenger of an autonomous vehicle 115, or an offloading attendant that witnesses passenger offloading, may supply a manual indication to device(s) 140 and/or device(s) 145 that all of the passengers of the particular vehicle 115 have finished offloading from the vehicle 115 such that the vehicle 115 located in the offloading pull-off area 200 can be sent for parking in parking facility 105, or to another destination. Completion of offloading includes all passengers disembarking from vehicle 115, and all items (e.g., stroller, child's diaper bag, wheelchair, powered scooter, etc.) that are to accompany the passengers being removed from vehicle 115.

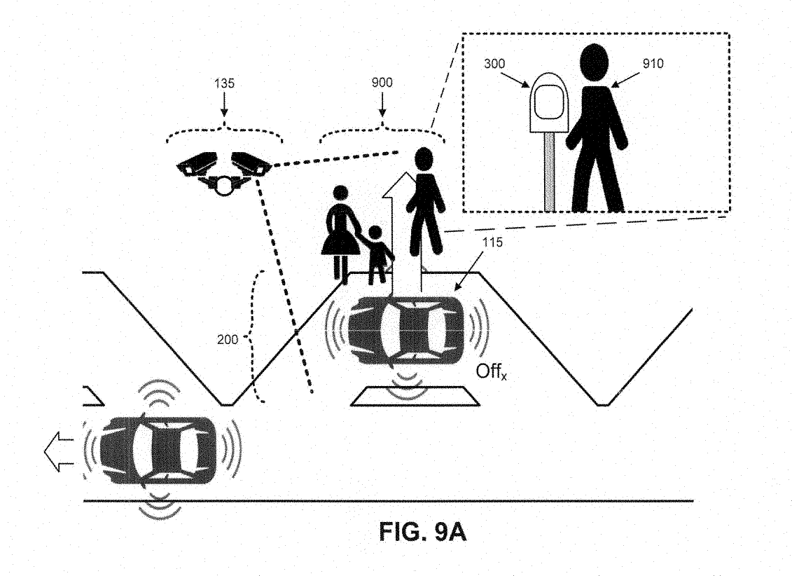

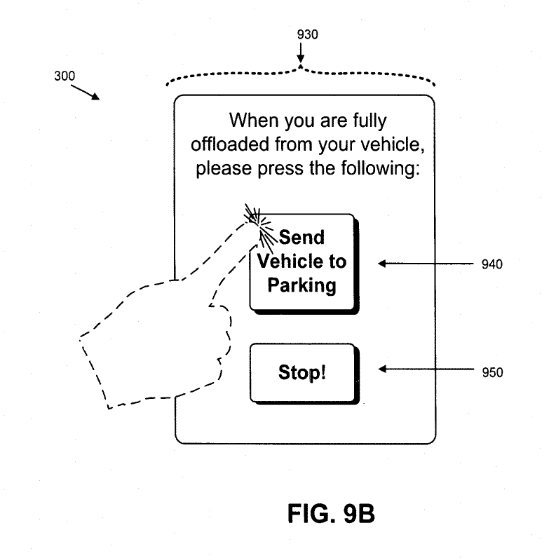

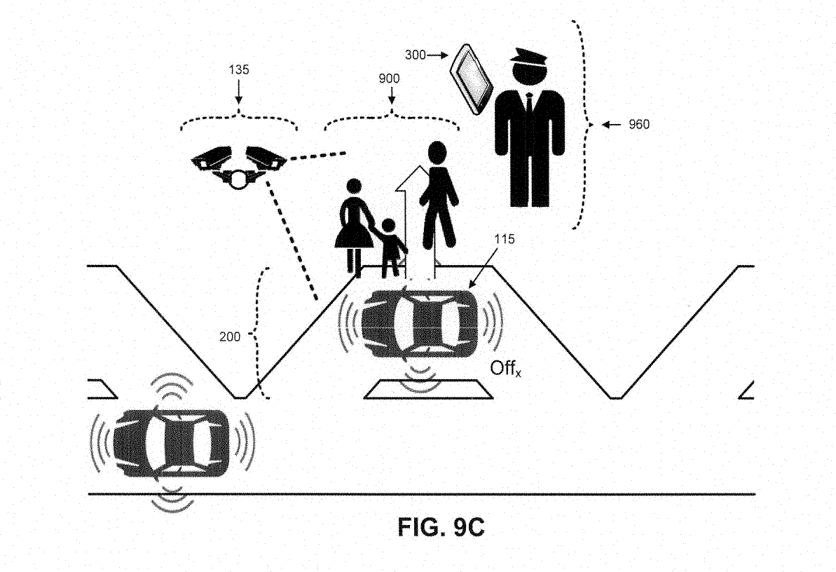

Each offloading station 300 may be permanently affixed to a location in close proximity to a respective offloading pull-off area 200, or may be a portable device, carried by an offloading attendant or by one of the disembarking passengers. If permanently affixed to a location relative to a respective offloading pull-off area 200, each offloading station 300 may, for example, be located approximately ten feet from where a vehicle 115 temporarily parks in each offloading pull-off area 200 for passenger offloading. If offloading station 300 is a portable device, offloading station 300 may include a mobile telephone (e.g., a “smart” phone), a personal digital assistant (PDA), a computer (e.g., laptop, tablet, palmtop or wearable computer), or a special-purpose computational device designed (e.g., in hardware and/or software) to perform the functions of offloading station 300. If offloading station 300 is a portable device, offloading station 300 may communicate with device(s) 140 and/or 145 via a PAN (e.g., employing a short distance wireless technology such as, for example, Insteon, Infrared Data Association (IrDA), Wireless Universal Serial Bus (USB), Bluetooth, Z-Wave, Zigbee, and/or Body Area Network), a wireless local area network (WLAN), a Public Land Mobile Network (PLMN), a wireless satellite network, or another type of wireless network. Further exemplary details of the use of the offloading stations 300-1 through 300-x at offloading pull-off areas 200-1 through 200-x, during passenger offloading, is described with respect to FIGS. 9A-9C below.

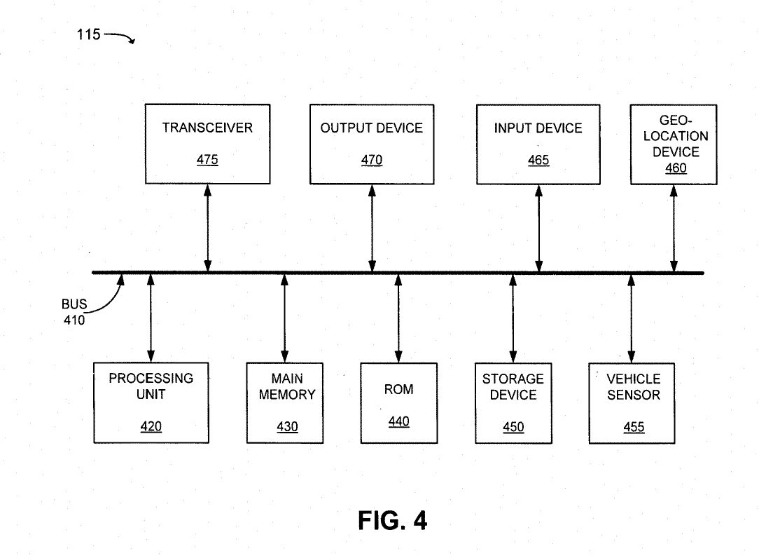

FIG. 4 is a diagram that depicts exemplary components of an autonomous vehicle 115. Device(s) 140, device(s) 145, and DB 150 may each include one or more devices configured similarly to autonomous vehicle 115 shown in FIG. 4, possibly with some differences or variations in components and/or configuration. Autonomous vehicle 115 may include a bus 410, a processing unit 420, a main memory 430, a read only memory (ROM) 440, a storage device 450, a vehicle sensor 455, a geo-location device 460, an input device 465, an output device 470, and a transceiver 475.

Bus 410 includes a path that permits communication among the components of autonomous vehicle 115. Processing unit 420 may include one or more processors or microprocessors, or processing logic (e.g., circuitry), which may execute instructions or perform operations. Main memory 430 may include a random access memory (RAM) or another type of dynamic storage device that may store information, and instructions for execution by processing unit 420. ROM 440 may include a ROM device or another type of static storage device that stores static information and instructions for use by processing unit 420. Storage device 450 may include a magnetic, flash memory, and/or optical recording medium. Main memory 430, ROM 440 and storage device 450 may each be referred to herein as a “non-transitory computer-readable medium” or a “non-transitory storage medium.”

Vehicle sensor 455 may include one or more sensor devices that sense various internal and/or external parameters associated with autonomous vehicle 115. For example, sensor 455 may include a digital compass that determines a current heading of vehicle 115, one or more radar units that sense an environment in proximity to vehicle 115, one or more lasers for determining a distance to obstacles, vehicles, and structures in proximity to vehicle 115, image/video cameras for taking images or video of the environment in proximity to vehicle 115, and/or an odometer that measures a distance that vehicle 115 has traveled. Vehicle sensor 455 may include one or more other types of sensor devices.

Geo-location device 460 includes a device that determines a current geographic location of autonomous vehicle 115. In one implementation, geo-location device 360 includes a Global Positioning System (GPS) device that determines, using the GPS satellite system, a current geographic position of autonomous vehicle 115. The geographic position may be tracked over time to determine a velocity and/or a heading of vehicle 115.

Input device 465 may include one or more devices that permit an operator to input information to vehicle 115, such as, for example, a keypad or a keyboard, a display with a touch sensitive panel, voice recognition and/or biometric mechanisms, etc. Output device 470 may include one or more devices that output information to an operator or user, including a display (e.g., with a touch sensitive panel), a speaker, etc. Input device 465 and output device 470 may be implemented as a graphical user interface (GUI) (e.g., a touch screen GUI that uses any type of touch screen device) that displays GUI information and which receives user input via the GUI.

Transceiver 475 may include one or more transceivers (e.g., transmitters and/or receivers) that enable autonomous vehicle 115 to communicate with other devices and/or systems. For example, transceiver 475 may include a first transceiver for communicating via a wireless PAN 160, a second transceiver for communicating via a wireless LAN 165, and/or a third transceiver for communicating via a PLMN(s) 170.

The configuration of components of autonomous vehicle 115 shown in FIG. 4 is for illustrative purposes. Other configurations may be implemented. Therefore, vehicle 115 may include additional, fewer and/or different components, arranged in a different configuration, than depicted in FIG. 4. Device(s) 140, device(s) 145, and DB 150 may include the same, or similar components, to those shown in FIG. 4, but may, for example, omit vehicle sensor 455 and/or geo-location device 460.

FIG. 5 is a diagram that depicts an exemplary implementation of autonomous vehicle offloading DB 150. As shown, a data structure of autonomous vehicle offloading DB 150 may include multiple entries 500, with each entry 500 including an autonomous vehicle identifier (ID) field 505, an offloaded timestamp field 510, an offloaded status field 515, an offloading time (t_{Off}) field 520, an offloaded passenger number field 525, a parking offloading position field 530, a “moving to:” field 535, a “moving from:” field 540, and a parking facility location field 545.

Autonomous vehicle ID field 505 stores data that includes a globally unique ID for a particular autonomous vehicle. Offloaded timestamp field 510 stores data that indicates a date and/or time at which the autonomous vehicle 115 identified in field 505 of the entry 500 was determined to be completely offloaded of passengers and/or passenger items. A value of zero in field 510 may indicate that the autonomous vehicle identified in field 505 of the entry 500 has not yet been completely offloaded.

Offloaded status field 515 stores a flag that indicates whether the autonomous vehicle identified in field 505 of the entry 500 has completely offloaded. If the flag is set (e.g., a value of 1), then the autonomous vehicle has been completely offloaded. If the flag is reset (e.g., a value of zero), then the autonomous vehicle has not been completely offloaded.

Offloading time (t_{Off}) field 520 stores data that indicates an elapsed time from a first moment at which the autonomous vehicle 115 identified in field 505 of the entry 500 has stopped for offloading in a passenger offloading area 200 until a second moment at which the autonomous vehicle 115 has been completely offloaded. Offloading time (t_{Off}) field 520 may store data indicating an elapsed time associated with in-progress passenger offloading of the vehicle identified in the corresponding field 505. Offloaded passenger number field 525 stores data that indicates a number of passengers that offloaded from the autonomous vehicle identified in field 505 of entry 500.

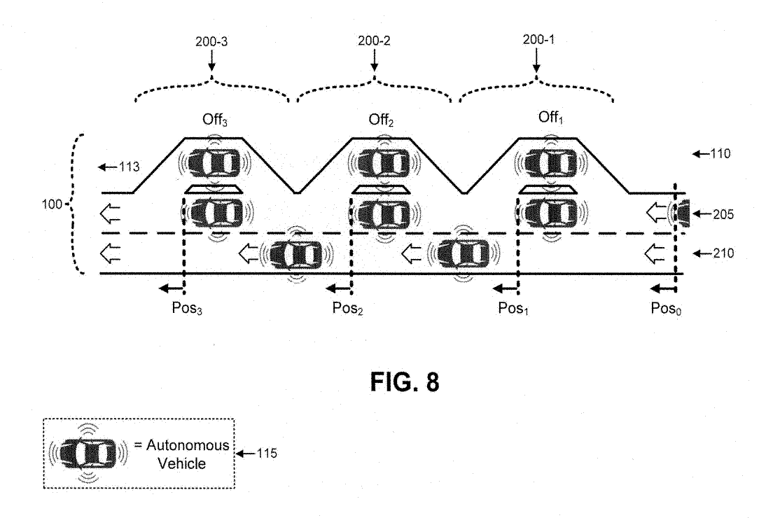

Parking offloading position field 530 stores data that identifies an offloading pull-off area 200 in passenger offloading area 100 at which the autonomous vehicle 115 identified in field 505 of the entry 500 has currently stopped for offloading, or a queuing position along turn lane 205 or thru lane 210 at which the vehicle 115 has stopped. Referring to FIG. 8 below, the position identified in field 530 may be one of offloading positions 200 (e.g., Off₁, Off₂, Off₃) or queuing positions (e.g., Pos₀, Pos₁, Pos₂) shown within passenger offloading area 100.

“Moving to:” field 535 stores data indicating a position within passenger offloading area 100 to which the autonomous vehicle 115 identified in field 505 is moving towards. The position may include queuing positions Pos₀-Posₙ along thru lane 210 or turn lane 205, or offloading positions 200 Off₁-Offₙ along turn lane 205 (see FIG. 8 below). “Moving from:” field 540 stores data indicating a position within parking offloading area 100 from which the autonomous vehicle 115 identified in field 505 is moving away. The position may include queuing positions Pos₀-Posₙ along thru lane 210 or turning lane 205, or offloading positions 200 Off₁-Offₙ along turning lane 205 (see FIG. 8 below). Parking facility location field 545 stores data indicating a parking location within parking facility 105 at which the autonomous vehicle 115 identified in field 505 may have parked subsequent to offloading of passengers in passenger offloading area 100. If the autonomous vehicle 115 departed the facility entirely (e.g., a taxi or a rideshare vehicle) then field 545 may store a code that indicates the vehicle is off-site.

To locate a particular entry of autonomous vehicle offloading DB 150, DB 150 may be queried with, for example, a vehicle ID to locate an entry 500 having a matching value stored in autonomous vehicle ID field 505. When such an entry 500 is located, data may be stored in one or more of fields 510-545 of the entry 500, or data may be retrieved from one or more of fields 510-545 of the entry 500. Other fields of an entry 500, instead of autonomous vehicle ID field 505, may alternatively be used for querying DB 150.

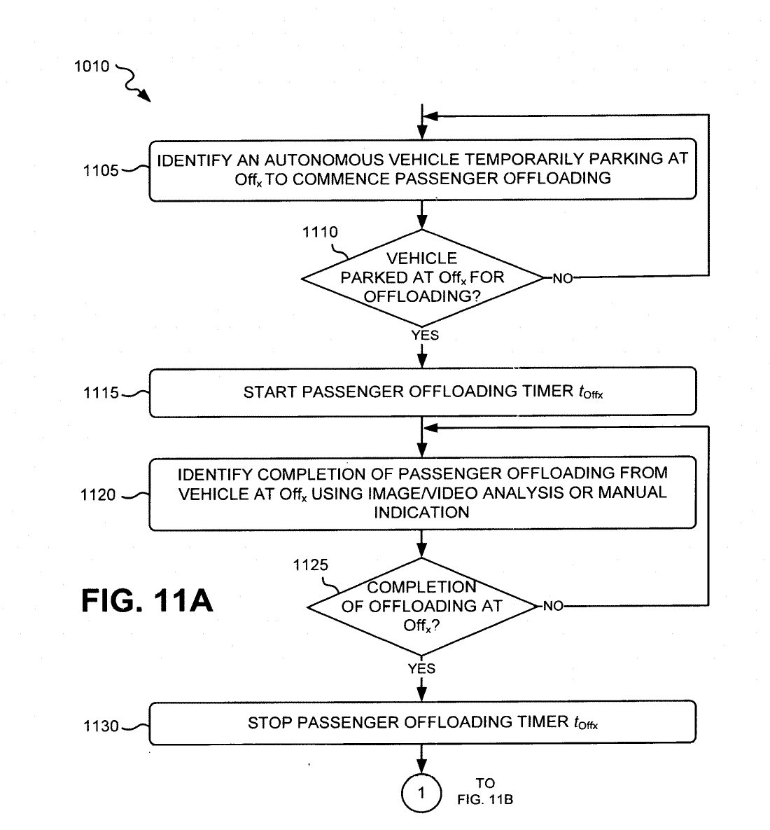

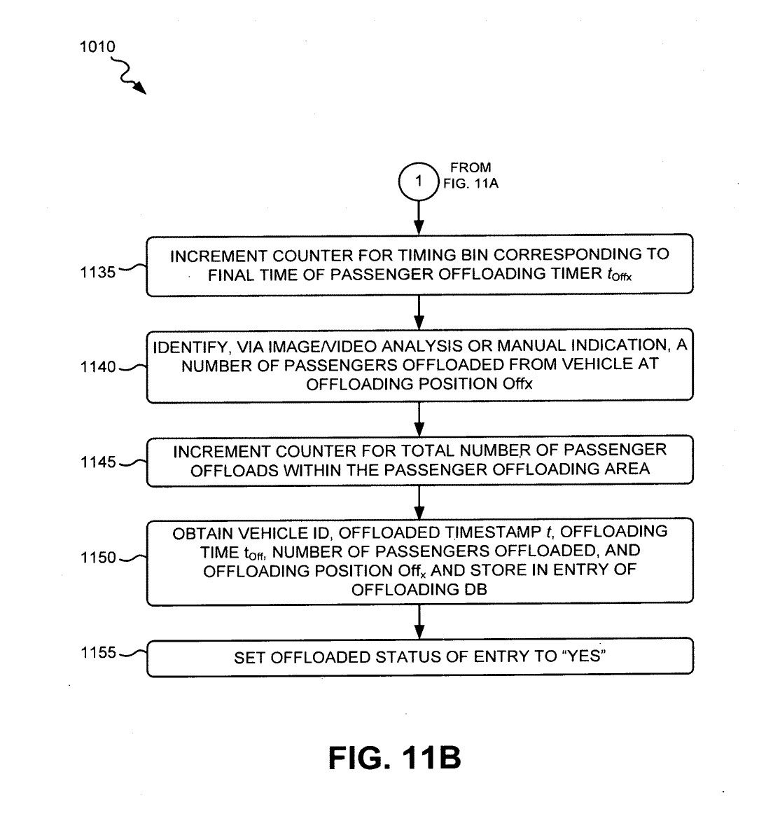

Autonomous vehicle offloading DB 150 is depicted in FIG. 5 as including a tabular data structure with certain numbers of fields having certain content. The tabular data structure of DB 150 shown in FIG. 5, however, is for illustrative purposes. Other types of data structures may alternatively be used. The number, types, and content of the entries and/or fields in the data structure of DB 150 illustrated in FIG. 5 is also for illustrative purposes. Other data structures having different numbers of, types of and/or content of, the entries and/or the fields may be implemented. Therefore, DB 150 may include additional, fewer and/or different entries and/or fields than those depicted in FIG. 5. For example, though not shown in FIG. 5, each entry 500 may additionally have one or more fields that identify the type, size, passenger capacity, and/or model of the autonomous vehicle 115 identified in field 505, as determined, for example, in block 1120 of FIG. 11A below. Additionally, each entry 500 may further have a field that identifies the number of passengers reported by the vehicle 115, itself, as being present within the vehicle 115 at the time of the start of passenger offloading within passenger offloading area 100, as described with respect to block 1120 of FIG. 11A below.

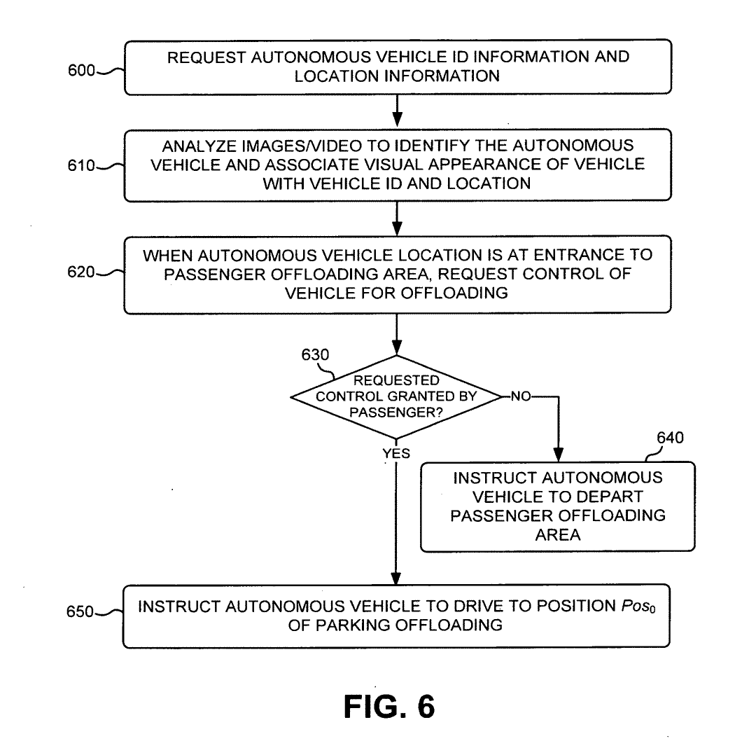

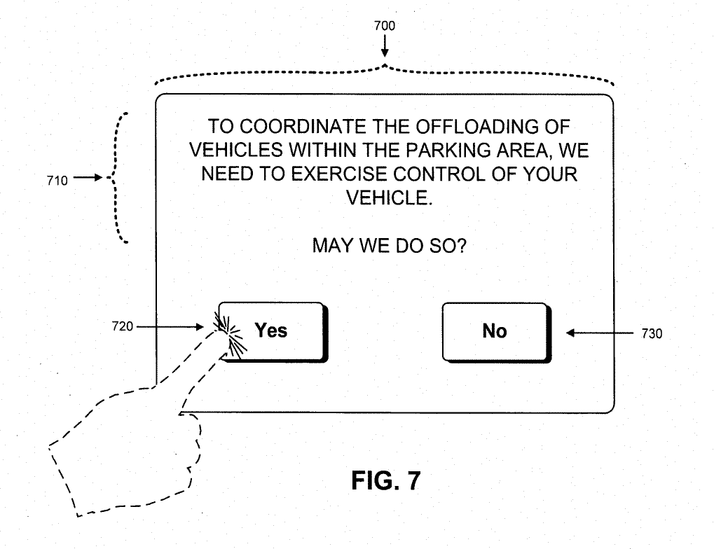

FIG. 6 is a flowchart that illustrates an exemplary process for asserting control over an autonomous vehicle 115 as the autonomous vehicle 115 approaches passenger offloading area 100 prior to offloading passengers and parking in parking facility 105, or departing to another destination. The exemplary process of FIG. 6 may, for example, be implemented by a processing unit 420 of device(s) 145. The exemplary process of FIG. 6 is described below with reference to FIG. 7.

The exemplary process includes device(s) 145 requesting autonomous vehicle ID information and location information from the autonomous vehicle 115 (block 600). As an autonomous vehicle 115 approaches an entrance to passenger offloading area 100, device(s) 145 transmits, via one or more wireless stations 130, a message to vehicle 115 requesting an ID of the vehicle 115, and location information of the vehicle 115. In response, vehicle 115 may obtain geographic position data from geo-location device 460 and a vehicle ID stored in memory 430, and may transmit a reply to device 145 via a wireless station(s) 130 and network(s) 125.

Device(s) 145 analyzes images or video, from one or more cameras 135, to identify the autonomous vehicle 115 and associate the visual appearance of the vehicle 115 with the vehicle ID and location information obtained in block 600 (block 610). Device(s) 145 receives images or video from a camera 135, located at an entrance to passenger offloading area 100 and whose point of view includes a known geographic area through which the vehicle 115 must pass. Device(s) 145 uses image/video recognition techniques to, for example, identify various visual parameters of the vehicle 115, such as, for example, the color, shape, make, model, year, and/or license plate number of the autonomous vehicle 115, and to associate the received vehicle ID with the recognized visual parameters.

Device(s) 145 requests control of the autonomous vehicle for offloading when the autonomous vehicle location is at the entrance 110 to the passenger offloading area 100 (block 620). Device(s) 145 may send a control request message, via network(s) 125 and a wireless station(s) 130, to vehicle 115 and, upon receipt, vehicle 115 may present the control request via a user interface of input device 465 of vehicle 115. For example, FIG. 7 depicts an exemplary touch screen user interface 700 contained within vehicle 115. As shown, a control request message 710 may be displayed to the passengers of vehicle 115 requesting the passengers to authorize device(s) 145 to exercise control over vehicle 115, including coordinated movement of vehicle 115, and other autonomous vehicles 115, through passenger offloading area 100. The displayed control request message 710 may additionally display a “yes” button 720 and a “no” button 730. Selection of the “yes” button 720 by the driver or passenger of the autonomous vehicle 115 authorizes device(s) 145 to begin exercising control over vehicle 115 through passenger offloading area 115 to parking facility 105 or to a departure point from the offloading area 100. Selection of the “no” button 730 rejects the exercise of control over vehicle 115 by device(s) 145.

Device(s) 145 determines if the requested control has been granted by a passenger of the autonomous vehicle 115 (block 630). If the requested control is not granted (NO—block 630), then device(s) 145 instructs the autonomous vehicle 115 to depart the passenger offloading area 100 (block 640). For example, referring to FIG. 7, to reject control, the passenger may select the “no” button 730 on the touch screen display. Device(s) 145 then issues instructions to vehicle 115 to depart the passenger offloading area 100, effectively denying vehicle 115 authorization to offload passengers or to park in parking facility 105. If the requested control is granted (YES—block 630), then device(s) 145 instructs the autonomous vehicle 115 to drive to position Pos₀ (see FIG. 8) of passenger offloading area 100 (block 650). For example, referring to FIG. 7, to grant control, the passenger may select the “yes” button 720 on the touch screen display.

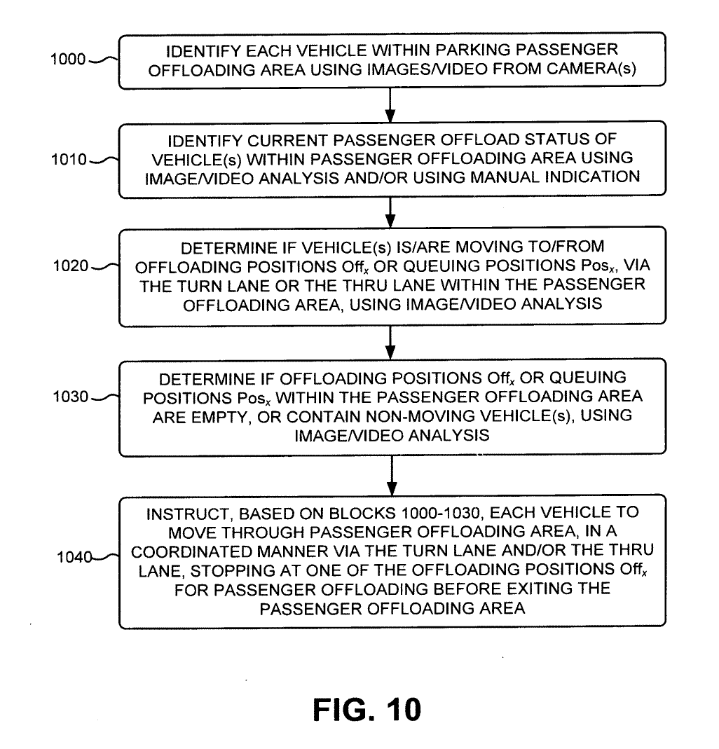

The exemplary process of FIG. 6 may be repeated, for each autonomous vehicle 115 that approaches the entrance 110 to passenger offloading area 100. Subsequent to completion of the process of FIG. 6, for each autonomous vehicle 115, the exemplary processes of FIGS. 10, 11A-11B, and 14A-14C may be executed.

FIG. 8 depicts a simplified example of passenger offloading area 100 of FIG. 2 that includes only three offloading pull-off areas 200-1, 200-2 and 200-3 (also referred to here as “offloading positions” 200-1, 200-2, and 200-3). As shown, passenger offloading area 100 includes two lanes, turn lane 205 and thru lane 210, with the three offloading pull-off areas 200-1, 200-2, and 200-3 being directly accessible via turn lane 205. Offloading pull-off area 200-1 is designated as offloading position “Off₁,” pull-off area 200-2 is designated as offloading position “Off₂,” and pull-off area 200-3 is designated as offloading position “Off₃.” Autonomous vehicles 115, as they enter the entrance 110 to parking offloading area 100, arrive at an initial position (Pos₀). From this initial position Pos₀, device(s) 145 instructs each vehicle 115 to proceed to a particular offloading pull-off area 200 so that the passengers of the vehicle can offload, and then device(s) 145 can instruct the vehicle 115 to proceed to park at a particular parking location in parking facility 105, or depart offloading area 100 and facility 105 entirely towards another destination, by proceeding to the exit 113 of the passenger offloading area 100.

During coordination of the offloading of multiple autonomous vehicles 115 within passenger offloading area 100, by device(s) 145, vehicles 115 may be instructed to stop at queuing positions Pos₁, Pos₂, and/or Pos₃, within turn lane 205 or thru lane 210, to enable other vehicles 115 to exit one of offloading pull-off areas 200, or to enter one of offloading pull-off areas 200. Upon departure from queuing position Pos₃, or pull-off area 200-3 Off₃, each vehicle 115 may depart through the exit 113 of passenger offloading area 100 and proceed towards parking facility 105 (not shown in FIG. 8) for the autonomous parking of each vehicle 115, or towards another destination not associated with parking facility 105.

In the simplified example of passenger offloading area 100 shown in FIG. 8, each vehicle 115 may be controlled by device(s) 145 such that it enters the entrance 110 to passenger offloading area 100 in turn lane 205 or thru lane 210 and drives, via turn lane 205 and/or thru lane 210, to a selected offloading pull-off area 200 to enable the vehicle 115's passengers to offload. Based on the coordination of traffic flow through turn lane 205 and thru lane 210, vehicle 115 may be instructed by device(s) 145 to temporarily stop at one or more of queuing positions Pos₁ through Posh along turn lane 205 or thru lane 210 to facilitate the movement of other vehicles 115 through passenger offloading area 100. Subsequent to completion of the passenger offloading, device 145 instructs the vehicle 115 to exit the offloading pull-off area 200, via thru lane 210 and exit 113, for parking at an instructed parking location in parking facility 105 or for proceeding to another destination not associated with parking facility 105 (e.g., a vehicle ride share facility), possibly temporarily stopping at one or more of queuing positions Pos₁ through Posₙ along thru lane 210 to facilitate the movement of other vehicles 115 through passenger offloading area 100.

Though only three offloading pull-off areas 200-1 through 200-3 are depicted in FIG. 8, passenger offloading area 100 may include 1 to n offloading pull-off areas 200, where n is greater than or equal to two, with turn lane 205 and thru lane 210 each extending the length of the n offloading pull-off areas (such as shown in FIG. 2). Though only four turn lane 205 and thru lane 210 queuing positions Pos₀ through Pos₃ are depicted in FIG. 8, passenger offloading area 100 may include 0 through m (0-m) turn lane 205 and thru lane 210 positions, where m is greater than or equal to three.

FIG. 9A depicts one example of a group of passengers 900 offloading from an autonomous vehicle 115 at an offloading pull-off area 200 in passenger offloading area 100. As shown, each member of the group of passengers 900 (e.g., a family of three is shown) disembarks from autonomous vehicle 115. Upon completion of the offloading, which includes all passengers disembarking and removal of all items that are to accompany the passengers 900 (e.g., stroller, child's diaper bag, wheelchair, powered scooter, etc.), one passenger 910 of the group of passengers 900 approaches an offloading station 300 that includes, for example, a device that permits passenger 910 to manually indicate that the group of passengers 900 are finished with their offloading from autonomous vehicle 115 such that vehicle 115 can be sent for parking in parking facility 105 (or to another destination). As shown, offloading station 300 may be located within proximity to a particular offloading pull-off area 200 such that offloading station 300 is associated with that particular pull-off area 200. In one example, offloading station 300 may be located 7-10 feet from offloading pull-off area 200, and disposed upon an upright pole, or within a structure that places the user accessible device of the offloading station 300 at a height to allow easy access for people within a certain height range.

In one implementation, as shown in FIG. 9B, offloading station 300 may include a device having a touch screen display 930. Display 930 may present a message to passengers 900, such as “When you are fully offloaded from your vehicle, please press the following:” followed by a first touch screen “button” 940 that permits selection of “send vehicle to parking” or “send vehicle to departure point” or a second touch screen “button” 950 that permits selection of “Stop!” such that the passenger 910 can instantly stop any movement of vehicle 115 out of offloading pull-off area 200 and towards parking facility 105 (or towards another destination). When passenger 910 touches button 940 upon touch screen display 930, device(s) 145 issues instructions to autonomous vehicle 115 to send it towards parking facility 105 for parking in a particular parking location or to send it towards another destination. If passenger 910 touches button 950 upon touch screen display 930, device(s) 145 issues instructions to autonomous vehicle 115 to return to a stopped position within offloading pull-off area 200. Passenger 910 may touch button 950 if, for example, passenger 910 discovers that a needed item was left in vehicle 115, and passenger 910 wishes to obtain the item from vehicle 115 prior to the vehicle 115 parking in parking facility 105.

FIG. 9C depicts another example of the group of passengers 900 offloading from an autonomous vehicle 115 at an offloading pull-off area 200 in passenger offloading area 100. As shown, each member of the group of passengers 900 (e.g., a family of three is shown) disembarks from autonomous vehicle 115. Upon completion of the offloading, which includes all passengers disembarking and removal of all items that are to accompany the passengers 900 (e.g., stroller, child's diaper bag, wheelchair, powered scooter, etc.), an offloading area attendant 960, who has viewed the group of passengers 900 offloading from their autonomous vehicle 115 and has visually verified that they have completed offloading, uses offloading station 300 to manually indicate to device(s) 140 and/or device(s) 145 that the group of passengers 900 are finished with their offloading from autonomous vehicle 115 such that the vehicle 115 located in offloading pull-off area 200 can be sent for parking in parking facility 105, or to another destination. Offloading station 300 used by the attendant 960 may include a touch screen display, that is the same as, or similar to, that shown in FIG. 9B, for manually indicating to device(s) 140 and/or device(s) 145 that the passengers 900 have completed their offloading of the autonomous vehicle 115. If a wireless device, offloading station 300 may transmit a message, via wireless station 130 and network(s) 125, to device(s) 140 and/or device(s) 145 that the passengers 900 have completed their offloading of the vehicle 115 and the vehicle 115 can be sent for parking in parking facility 105 or on to another destination.

FIG. 10 is a flowchart that illustrates an exemplary process for controlling, in a coordinated manner, the movement of autonomous vehicles 115 through passenger offloading area 100 and to parking facility 105 for vehicle parking (or to another destination). The exemplary process of FIG. 10 coordinates the offloading of autonomous vehicles 115 at offloading pull-off areas 200 in passenger offloading area 100 to maximize the flow of vehicles through passenger offloading area 100, to minimize the waiting time of passengers within the vehicles 115 that are waiting to offload from their respective vehicles 115, and to maximize the safety of vehicles, passengers, and pedestrians within passenger offloading area 100.

The exemplary process includes device(s) 140 identifying each vehicle 115 within passenger offloading area 100 using images/video from camera(s) 135 (block 1000). Device(s) 140 receives images/video from cameras 135-1 through 135-m via network(s) 125 and uses image/video recognition techniques to identify each autonomous vehicle 115 within passenger offloading area 100 based on the images/video. The vehicle ID of each vehicle 115, and the vehicle's visual appearance (e.g., including vehicle license plate number), were previously associated (in blocks 600 and 610 of FIG. 6) using image/video recognition techniques. Device(s) 140 uses the previous association of vehicle visual appearance, vehicle geographic location, and the vehicle ID, to visually identify, and keep track of, each autonomous vehicle 115 within the viewing areas of cameras 135-1 through 135-m in passenger offloading area 100.

Device(s) 140 identifies the current passenger offloading status of vehicles 115 within passenger offloading area 100 using image/video analysis and/or using manual indication (block 1010). In one implementation, as described above with respect to FIGS. 9A and 9B, one of the passengers of a group of passengers offloaded from a vehicle 115 uses a device associated with an offloading station 300 to manually indicate that the group of passengers 900 is finished with their offloading from autonomous vehicle 115. In another implementation, as described above with respect to FIG. 9C, a parking offloading area attendant, who has viewed a group of passengers offloading from an autonomous vehicle 115 and has visually verified that they have completed offloading, uses a device to manually indicate to device(s) 140 and/or device(s) 145 that the group of passengers 900 is finished with their offloading from vehicle 115. In a further implementation, device(s) 140 may receive image(s)/video from cameras 135-1 through 135-m and may use image/video recognition techniques to determine when offloading of each vehicle 115 at a passenger offloading pull-off area 200 has completed. The image/video recognition technique may analyze the image(s)/video to identify when all passengers have offloaded from the vehicle 115, and have departed the vicinity of the offloading pull-off area 200. For example, if image(s)/video analysis determines that all passengers have offloaded from the vehicle 115, and have walked a minimum threshold distance away from the offloading pull-off area 200 (e.g., walked 5 yards away from area 200), then the image(s)/video analysis identifies that the vehicle 115 has been completely offloaded and may be instructed to depart the offloading pull-off area 200 for parking in parking facility 105 or for proceeding towards another destination. Details of one exemplary implementation of block 1010 of FIG. 10 are described below with respect to FIGS. 11A and 11B.

Device(s) 140 determines if autonomous vehicles 115 is/are moving from offloading positions Offₓ or queuing positions Posₓ, via the turn lane 205 or the thru lane 210, within the passenger offloading area 100, using image/video analysis (block 1020). Device(s) 140, using image(s)/video recognition techniques, analyzes image(s)/video of all vehicles 115 located within passenger offloading area 100 within the viewing coverage area of cameras 135-1 through 135-m, and determines the movement status of each vehicle 115 and each vehicle's current location within passenger offloading area 100. For example, device(s) 140, using image(s)/video recognition, may determine that a vehicle 115 is:

1) stopped at a queuing position Posₓ in turn lane 205 or thru lane 210,

2) is moving away from an offloading position Offₓ,

3) is moving towards an offloading position Offₓ,

4) is moving away from a queuing position Posₓ in turn lane 205 or thru lane 210, or

5) is moving towards a queuing position Posₓ in turn lane 205 or thru lane 210.

Device(s) 140 determines if the offloading positions Offₓ or queuing positions Posₓ with the passenger offloading area 100 are empty, or contain non-moving vehicle(s), using image/video analysis (block 1030). Device(s) 140, using image(s)/video recognition techniques, analyzes image(s)/video of viewing coverage areas of cameras 135-1 through 135-m to determine whether a vehicle 115 is currently located at each offloading position Offₓ (i.e., temporarily stopped for offloading), or each queuing position Posₓ within passenger offloading area 100, or whether each offloading position Offₓ and each queuing position Posₓ is currently empty.

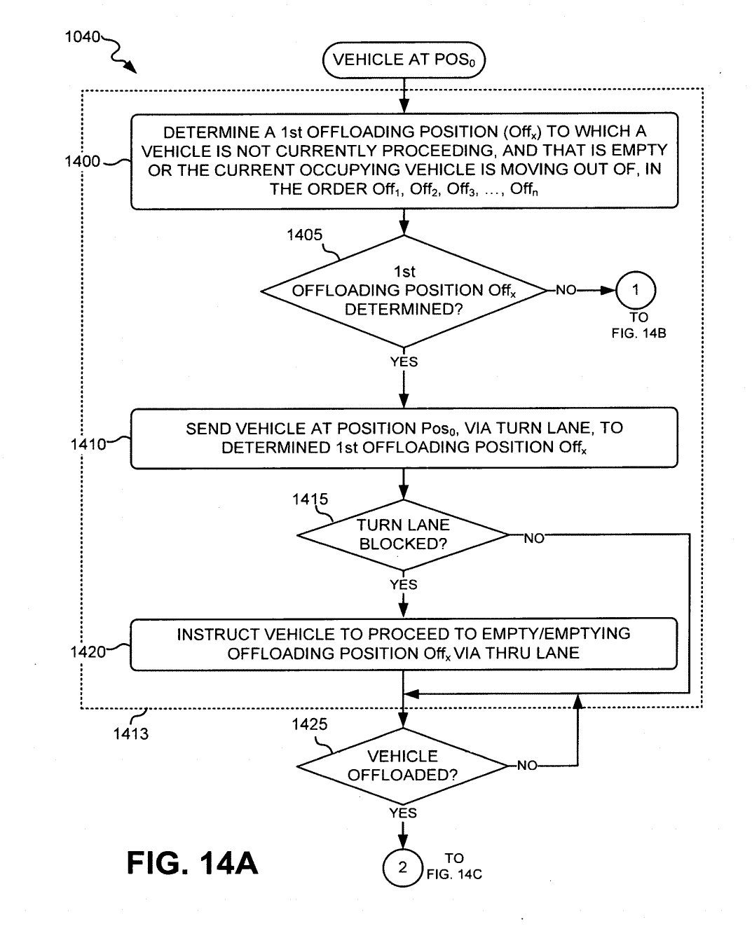

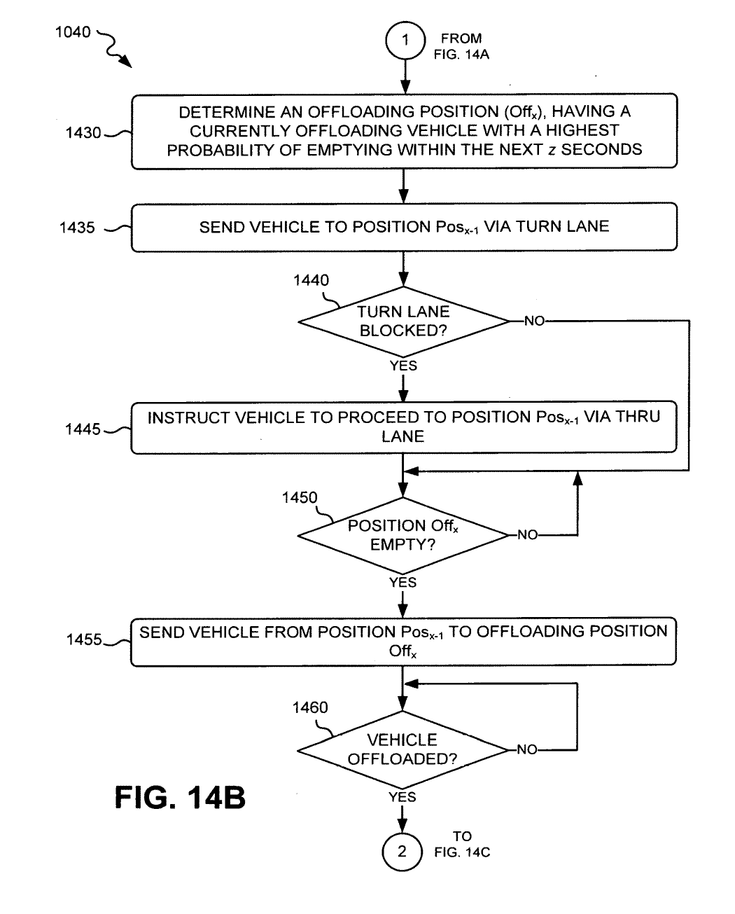

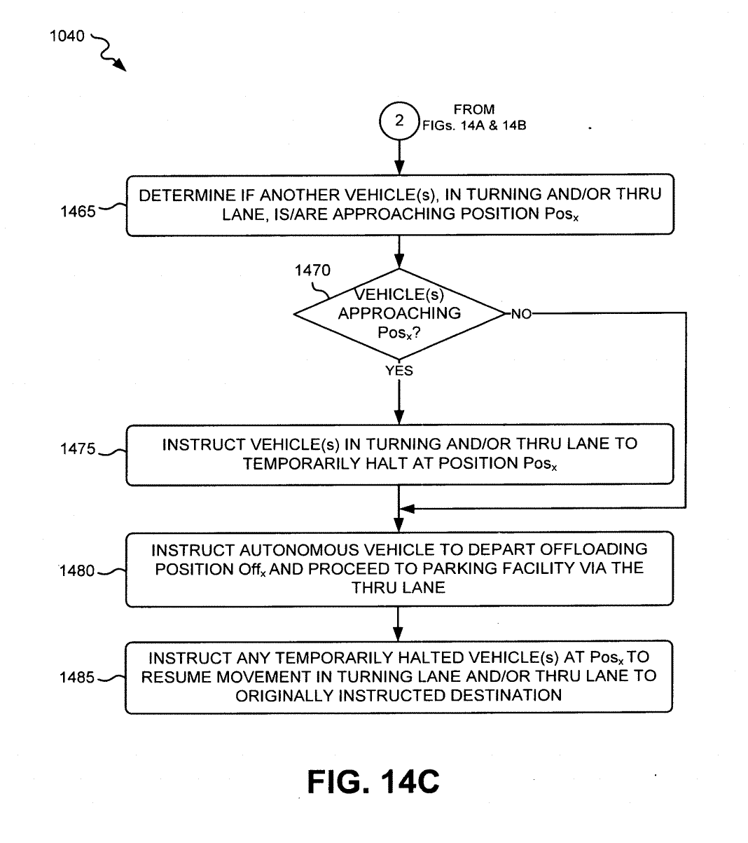

Device(s) 145 instructs, based on the monitoring performed in blocks 1000-1030, each autonomous vehicle 115 to move through passenger offloading area 100, in a coordinated manner via the turn lane 205 and/or the thru lane 210, stopping at one of the offloading positions Offₓ, for passenger offloading before exiting the passenger offloading area 100 (block 1040). Device(s) 145 coordinates the movement of all vehicles 115 through passenger offloading area 100, and the offloading of each of the vehicles 115 at a designated offloading pull-off area 200 in the passenger offloading area 100, to maximize the flow of vehicles through passenger offloading area 100 and to minimize the waiting time of passengers within the vehicles 115 that are waiting to offload from their respective autonomous vehicles 115. Device(s) 145 may obtain the monitoring data, generated in blocks 1000-1030, from monitoring device(s) 140, or from DB 150. Details of one exemplary implementation of block 1040 of FIG. 10 are described below with respect to FIGS. 14A-14C. Device(s) 145 coordinates the movement of all vehicles 115 through passenger offloading area 100 by providing instructions to proceed to, and temporarily stop at, certain positions (Offₓ or Posₓ) within passenger offloading area 100 for the offloading of passengers, and eventual proceeding of each vehicle 115 for parking in parking facility 105 or towards another destination not associated with parking facility 105. However, each autonomous vehicle 115 uses existing techniques of autonomous driving, including avoidance of collisions, driving at an appropriate speed, etc. to drive to the instructed positions within the passenger offloading area 100 or parking facility 105, where such known techniques are only modified via specific instructions from device(s) 145. Therefore, for example, when a vehicle 115 is instructed by device(s) 145 to proceed from entrance 110 of passenger offloading area 100 to an offloading position Offₓ via turn lane 205, the vehicle 115 uses known techniques for safe autonomous driving to drive to the offloading position Offₓ via turn lane 205 while maintaining a safe speed, staying within the driving lane, avoiding hitting other vehicles or pedestrians, etc.

FIGS. 11A and 11B are flowcharts that illustrate an exemplary implementation of block 1010 of FIG. 10 involving the determination of the current passenger offload status of passengers offloading from autonomous vehicles 115 at an offloading position 200 Offₓ of passenger offloading area 100. The exemplary process of FIGS. 11A and 11B may be executed for each offloading position Offₓ within passenger offloading area 100. For example, if passenger offloading area 100 includes ten offloading positions Off₁-Off₁₀, then ten independent instances of the process of FIGS. 11A and 11B may be executed by device(s) 140.

The exemplary process includes device(s) 140 identifying an autonomous vehicle 115 temporarily parking at Offₓ and passenger offloading commencing (block 1105). Device(s) 140, using image(s)/video received from cameras 135 and image/video recognition techniques, determines when an autonomous vehicle 115 has arrived at a parking offloading position Offₓ and temporarily parked to permit the offloading of passengers. Device(s) 140 further uses image/video recognition techniques to identify that the passenger(s) carried within the autonomous vehicle 115 have commenced offloading from the vehicle 115. Device(s) 140 may identify that offloading has commenced from vehicle 115 by determining that the vehicle 115 has completely stopped within offloading area 200, and/or at least one passenger has begun disembarking from the vehicle 115.

If an autonomous vehicle 115 has temporarily parked at offloading position Offₓ for the commencement of offloading (YES—block 1110), then device(s) 140 starts the passenger offloading timer t_{Offx} (block 1115). The passenger offloading timer t_{Offx} may include a timing counter that counts an elapsed amount of time from a moment at which a vehicle 115 stops at an offloading position Offₓ to commence offloading, and the moment at which the passenger offloading has completed and the vehicle 115 is ready to proceed to parking facility 105 for parking. Device(s) 140, therefore, keeps track of the amount of time each vehicle 115 takes to be offloaded of passengers at a respective offloading area 200. A current value of passenger offloading timer t_{Offx} may be stored in field 520 of an entry 500 of DB 150 having a vehicle ID in field 505 that matches the autonomous vehicle 115 currently offloading. The current value of passenger offloading timer t_{Offx} stored in field 520 may be continually updated until a final offloading time is reached (i.e., offloading has completed), and the final value of the passenger offloading timer is then stored in field 520. If the autonomous vehicle 115 has not yet parked at offloading position Offₓ (NO—block 1110), then block repeats 1110.

Device(s) 140 identifies completion of the passenger offloading from the vehicle 115 at offloading position Offₓ using image/video analysis or a manual indication (block 1120). Manual indication of the completion of passenger offloading is described with respect to FIGS. 3B and 9A-9C above. Automatic identification of the completion of passenger offloading, using image/video recognition techniques, is described with respect to block 1010 of FIG. 10 above. Additionally, device(s) 140 may determine, based on image/video analysis, a type, size, passenger capacity, and/or model (e.g., Sports Utility Vehicle (SUV), van, minivan, compact, subcompact, full-size, etc.) of the autonomous vehicle 115 from which the passengers are offloading. Alternatively, device(s) 140 may query each autonomous vehicle 115 to request a reply from vehicle 115 that includes data identifying the type, size, passenger capacity, and/or model of the vehicle 115 and/or a number of known passengers occupying the vehicle 115 prior to offloading. In response, vehicle 115 may send a message that includes data identifying the type, size, passenger capacity and/or model of the vehicle 115 and/or identifies the number of passengers within vehicle 115. Vehicle 115 may, for example, obtain information regarding the number of passengers within vehicle 115 by seat sensors, image/video recognition using one or more cameras within the vehicle, door entry sensors (e.g., three passengers detected entering through the vehicle doors), etc. The type, size, passenger capacity, and/or model of the autonomous vehicle 115, and/or the number of passengers seated within vehicle 115, may be immediately stored in DB 150 to serve as a basis for predictions of a time for completion of passenger offloading prior to the passenger offloading actually completing.

If offloading of passengers at offloading position Offₓ has not completed (NO—block 1125) and is still ongoing, then block 1125 repeats. If offloading of passengers at offloading position Offₓ has completed (YES—block 1125), then device(s) 140 stops the passenger offloading timer t_{Offx} (block 1130). Device(s) 140 stops the counting of offloading timer torr; such that the timer identifies a total amount of elapsed time it has taken for the vehicle 115 to come to a stop at an offloading position Offₓ, and to be completely offloaded of passengers and passenger items (e.g., strollers, etc.).

Device(s) 140 increments a counter for a timing bin corresponding to the final time of passenger offloading timer t_{Offx} (block 1135). The passenger offloading time may have a range of values from several seconds to a few/several minutes. For example, the time it takes for passengers to offload from all vehicles 115 may range from 4.6 seconds to 5.0 minutes. This range of time may be called the “total range” and may be evenly divided into sub-ranges, with each sub-range being associated with a “timing bin.” For example, the total range of 4.6 seconds to 5.0 minutes may be divided into sub-ranges of 0.4 seconds each, with a timing bin corresponding to each of the sub-ranges. When a final time of the passenger offloading timer t_{Offx} falls within the sub-range that corresponds to a particular timing bin, a counter associated with that timing bin is incremented. For example, a timing bin having a current counter value of zero is incremented to a value of one when a vehicle 115 offloads within a time that falls within a sub-range of time that corresponds to the timing bin.

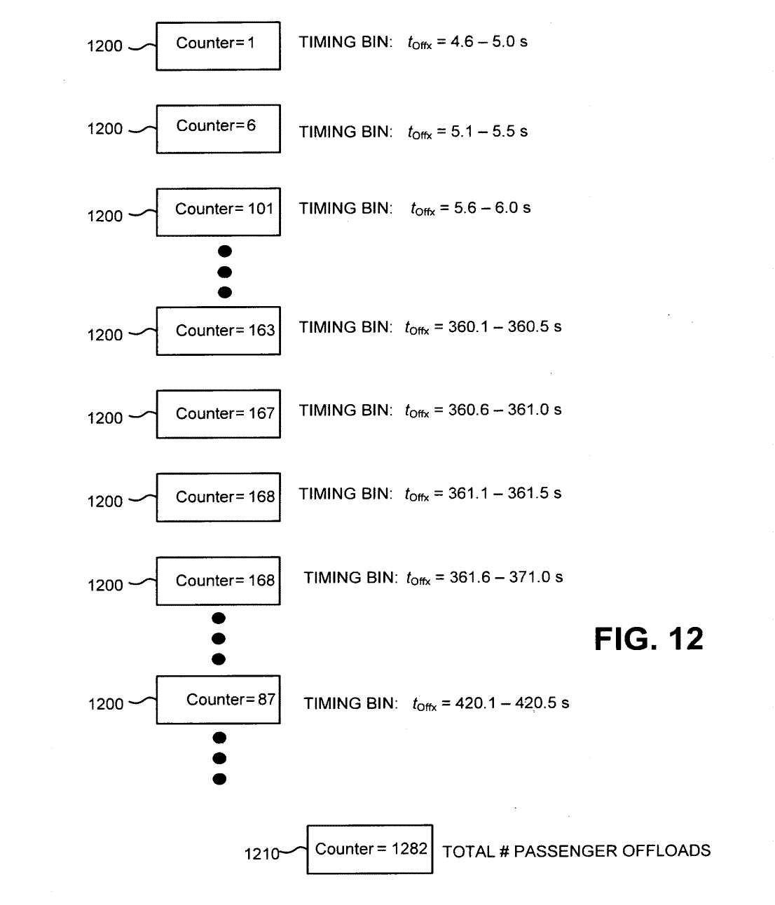

Referring to an illustrative example depicted in FIG. 12, multiple counters 1200 are associated with respective timing bins, with each timing bin corresponding to a sub-range of 0.4 seconds. For example, as shown in FIG. 12, a first timing bin may have a timing range of t_{Offx}=4.6-5.0 seconds and a counter value of 1 (i.e., one previous vehicle 115 offloaded within a time that falls within 4.6 to 5.0 seconds), a next timing bin may have a timing range of t_{Offx}=5.1-5.5 seconds and a counter value of 6 (i.e., six previous vehicles 115 offloaded within times that fell within 5.1 to 5.5 seconds), a subsequent timing bin may have a timing range of t_{Offx}=5.6-6.0 seconds and a counter value of 101 (i.e., 101 previous vehicles 115 offloaded within times that fell within 5.6 to 6.0 seconds), etc. As shown in FIG. 12, a counter 1210 additionally counts a global total number of passenger offloads that occur within passenger offloading area 100 over a certain period of time. The period of time may be, for example, a week, a month, or a year. Alternatively, the global total number of passenger offloads may be a cumulative total number without reference to a particular period of time. The global total number of passenger offloads, counted by counter 1210, would, therefore, be the sum of all of the counter values of counters 1200.

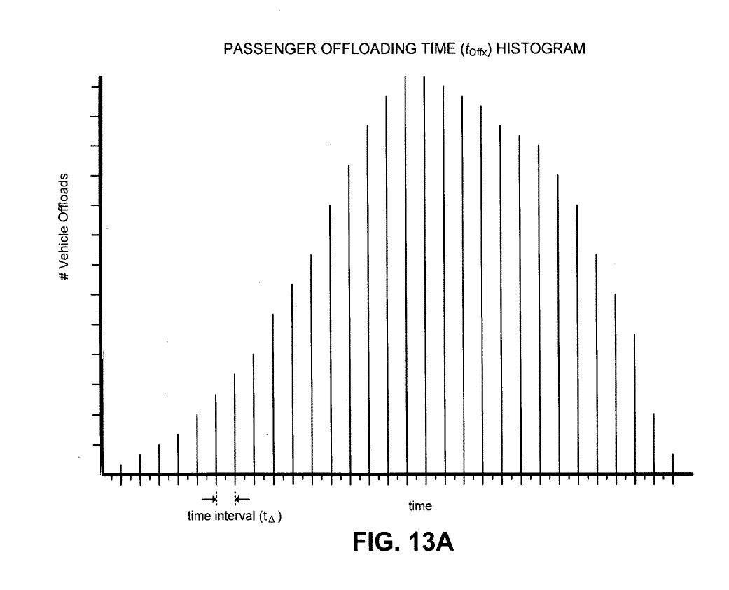

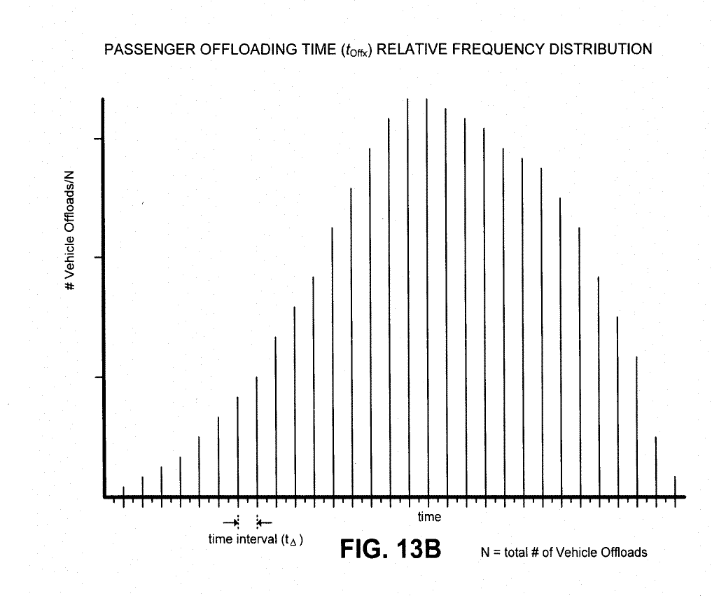

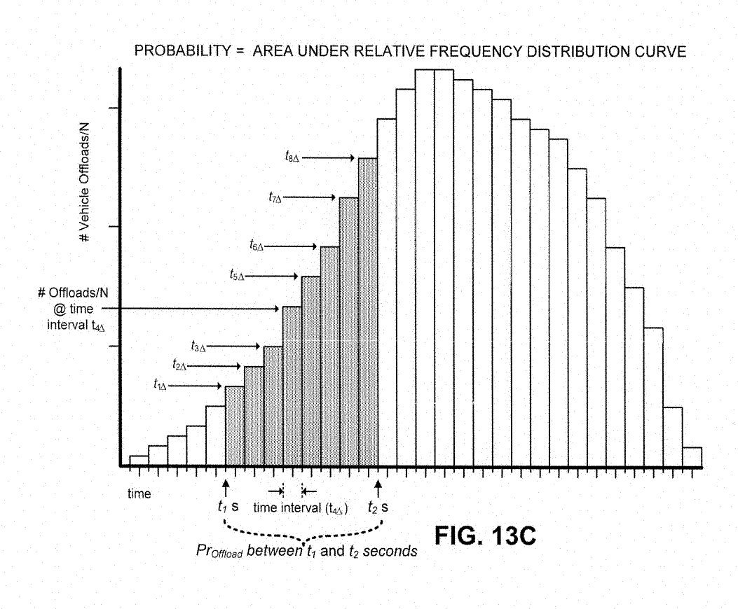

FIG. 13A depicts a two-dimensional representation of a histogram of a number (#) of vehicle offloads vs. passenger offloading time (t_{Offx}). The x axis in the histogram of FIG. 13A represents time in a sequence of evenly spaced time intervals t_{Δ}, where t_{Δ} corresponds to the timing bin sub-range described above with respect to FIG. 12. They axis in the histogram of FIG. 13A represents a total number (#) of vehicle offloads that falls within each time interval t_{Δ}, where the total number of vehicle offloads within each time interval t_{Δ} corresponds to a counter value 1200 associated with each timing bin of FIG. 12. Therefore, all of the counter values 1200 associated with all of the timing bins of FIG. 12 may be plotted to create the histogram of FIG. 13A.

Device(s) 140 increments a counter for a timing bin corresponding to the final time of passenger offloading timer t_{Offx} (block 1135). Referring again to FIG. 12, in one particular example, if the passenger offloading timer t_{Offx} for a vehicle 115 offloading within parking offloading area 100 is 360.8 seconds, then the corresponding counter for that timing bin is incremented from 167 to 168, and counter 1210 is incremented from 1282 to a total number of passenger offloads of 1283.

Device(s) 140 identifies, via image/video analysis or manual indication, a number of passengers that offloaded from the autonomous vehicle at offloading position Offₓ (block 1140). In an implementation in which the number of passengers that offload from a vehicle 115 is entered manually, the attendant, such as shown in FIG. 9C, may manually enter, via offloading station 300, the number of passengers that the attendant witnesses offloading from a particular vehicle 115. Alternatively, device(s) 140 may receive an image(s)/video from one or more cameras 135 and may analyze the image(s)/video, using image/video recognition techniques, to identify passengers offloading from a vehicle 115, and to count the number of passengers that offload. Device(s) 140 stores the counted number of offloaded passengers in field 525 of an entry 500 that corresponds to the vehicle 115 from which the passengers offloaded.

Device(s) 140 increments a counter for the total number of passenger offloads within the passenger offloading area 100 (block 1145). Referring to FIG. 12, device(s) 140 may increment counter 1210 to reflect the cumulative total number of vehicles 115 that have been offloaded within passenger offloading area 100. Counter 1210, thus, keeps track of the total number of vehicles 115 offloaded, but does not keep track of the total number of passengers offloaded.

FIG. 13B further depicts a two-dimensional representation of the relative frequency distribution of the passenger offloading time (t_{Offx}). The x axis in the relative frequency distribution of FIG. 13B represents, the same as shown in FIG. 13A, time in a sequence of evenly spaced time intervals t_{Δ}. They axis in the histogram of FIG. 13A represents a total number of vehicle offloads, that falls within each time interval t_{Δ}, divided by the total number of vehicle offloads N across all time intervals t_{Δ}, where the total number of vehicle offloads within each time interval t_{Δ}, divided by N corresponds to a counter value 1200 associated with each timing bin of FIG. 12 divided by the counter value of counter 1210. Referring to FIG. 12, in one particular example, the counter value 1200 of 167, for the timing bin of t_{Offx}=360.6-361.0s, is divided by the counter value 1210 of 1282 to generate the “# vehicle offloads/N” value of 167/1282 for timing bin (t_{Δ}) t_{Offx}=360.6-361.0s.

FIG. 13C depicts probability values associated with the relative frequency distribution curve of FIG. 13B. A probability value consists of the fraction of the area under a frequency distribution curve corresponding to a specific interval of time. Therefore, the probability of the occurrence of passenger offloading times within a time period range may be determined by calculating the probability of the area under the relative frequency distribution curve of FIG. 13B, where the area corresponds to the particular interval of time for which a probability is to be determined. Referring to FIG. 13C, a probability of offloading can be determined, based on the relative frequency distribution curve of FIG. 13B, for an interval spanning t₁ seconds to t₂ seconds. As shown in the illustrative example of FIG. 13C, the time interval spanning t₁ seconds to t₂ seconds includes 8 different timing bin intervals t₁Δ, t_{2Δ}, t_{3Δ}, t_{4Δ}, t_{5Δ}, t_{6Δ}, t_{7Δ}, and t_{8Δ} (shown highlighted). By multiplying the # Offloads/N at each timing bin interval t_{Δ} by the length of the timing bin interval t_{Δ}, and adding all of these values together, the probability of offload (Pr_{Offload}) within the time interval spanning t₁ to t₂ seconds may be determined. Therefore, Pr_{Offload}, between t₁ and t₂ seconds, as shown in the example of FIG. 13C, equals (# Offloads/N @time interval t_{1Δ}*t_{1Δ})+(# Offloads/N @time interval t_{2Δ}*t_{2Δ})+(# Offloads/N @time interval t_{3Δ}*t_{3Δ})+(# Offloads/N @time interval t_{4Δ}*t_{4Δ})+(# Offloads/N @time interval t_{5Δ}*t_{5Δ})+(# Offloads/N @time interval t_{6Δ}*t_{6Δ})+(# Offloads/N @time interval t_{7Δ}*t_{7Δ}), and (# Offloads/N @time interval t_{8Δ}*t_{8Δ}) In a similar fashion to that shown in FIG. 13C, a predicted probability of offloading within any time interval t₁ to t₂, where t₁ to t₂ is an integer multiple of the timing bin interval t_{Δ}, may be determined. In one example t₁ may be set equal to zero, and t₂ may be any subsequent time, and Pr_{Offload} can be determined between the beginning of passenger offloading of a particular vehicle 115 at time t=0 and subsequent time t₂.

Device(s) 140 obtains a vehicle ID for the offloaded vehicle 115, the offloaded timestamp t, the offloading time t_{Offx}, a number of passengers offloaded, and an offloading position Offₓ, and stores in an entry 500 of offloading DB 150 (block 1150). Device (s) 140 determines a current time (e.g., in hour:minutes:seconds format) and a current date (in month:day:year format) and designates the current time/date as the offloaded timestamp t. Device(s) 140 obtained the offloading time t_{Offx} in blocks 1115 through 1130, the number of passengers offloaded in block 1140, and the offloading position Offₓ in block 1105. Device(s) 140 stores the offloading time t_{Offx} in field 520, the number of passengers offloaded in field 525, and the offloading position Offₓ in field 530, of an entry 500 whose vehicle ID stored in field 505 matches the vehicle ID of the vehicle 115 offloaded. Device(s) 140 sets the offloaded status field 515 of entry 500 to “yes” (block 1155), indicating that the vehicle 115 corresponding to the vehicle ID in field 505 of the entry 500 has been completely offloaded.

The exemplary process of FIGS. 11A and 11B may be repeated by device(s) 140 for each autonomous vehicle 115 that comes to a stop at an offloading position Offₓ within parking offloading area 100 for passenger offloading.

FIGS. 14A-14C are flowcharts that illustrate an exemplary process for the control of the movement of an autonomous vehicle 115, through passenger offloading area 100, in coordination with the movement of other autonomous vehicles 115 also moving through passenger offloading area 100. The exemplary process of FIGS. 14A-14C may be implemented by device(s) 140 and/or device(s) 145. Referring to FIG. 8, the exemplary process of FIGS. 14A-14C may be executed for each autonomous vehicle 115 that arrives at an entry queuing position Pos₀ of passenger offloading area 100. FIGS. 14A-14C include details of one exemplary implementation of block 1040 of the process of FIG. 10.

The exemplary process includes device(s) 140 and/or device(s) 145 determining a first offloading position (Offₓ), in the order of Off₁, Off₂, Off₃, . . . , Offₙ, that satisfies the criteria (block 1400):

1) an autonomous vehicle 115 is not currently proceeding to the offloading position Offₓ; and

2) the offloading position Offₓ is empty or the current occupying vehicle 115 is moving out of the offloading position Offₓ.

Device(s) 140 and/or device(s) 145 analyzes an image(s)/video from cameras 135, using image/video recognition techniques, to determine the closest offloading position Offₓ, of offloading positions Off₁, Off₂, Off₃, . . . , Offₙ, to the first queuing position Pos₀ to which no autonomous vehicles 115 have been instructed to proceed to, and that is currently empty of vehicles 115 or which the current occupying vehicle 115 has been instructed to move out of. For example, if offloading positions Off₂ and Off₇ are currently empty, offloading position Off₂, being the closest to queuing position Pos₀, is selected as the offloading position to which the vehicle 115 at position Pos₀ is sent for offloading. As another example, if vehicles 115 are currently moving out of offloading positions Off₃ and Off₈, offloading position Off₃, being the closest to queuing position Pos₀, is selected as the offloading position to which the vehicle at position Pos₀ is sent for offloading.

If a first offloading position Offₓ is determined (YES—block 1405), then device(s) 140 or device(s) 150 sends the autonomous vehicle 115 at position Pos₀, via turn lane 205, to the determined first empty offloading position Offₓ (block 1410). Device(s) 140 and/or device(s) 145 may send a message to vehicle 115, via network(s) 125 and one or more of wireless stations 130, where the message includes instructions to drive from position Pos₀ to the determined offloading position Offₓ via turn lane 205. The instructions may, in one implementation, include accurate geographic coordinates of the determined offloading position Offₓ 200 that the vehicle 115 may use to compare with its current measured geographic coordinates, via geo-location device 460, to determine where vehicle 115 must proceed. Referring to FIG. 8, the autonomous vehicle 115 starts at position Pos₀ and, after receiving instructions to proceed to offloading position Offₓ, drives via turn lane 205 to the offloading position Offₓ, where Offₓ may be any one of Off₁, Off₂, . . . , Offₙ.

Device(s) 140 and/or device(s) 145 determines if turn lane 205 is blocked (block 1415). The turn lane 205 is blocked if device(s) 140 and/or device(s) 145 determines that another vehicle 115 is currently located in turn lane 205, or is heading into turn lane 205, and obstructs, or will obstruct, the current vehicle 115's path to the determined first empty offloading position Offₓ. Another vehicle 115 may obstruct turn lane 205, for example, by being temporarily halted at a queuing position Posₓ within turn lane 205 such that the vehicle 115, while transiting turn lane 205 to arrive at the offloading position Offₓ would become blocked behind the other temporarily halted vehicle 115. Additionally, another vehicle 115 may obstruct turn lane 205, if device(s) 140 and/or device(s) 145 has instructed another vehicle 115 to enter turn lane 205 in front of the current vehicle 115 such that the current vehicle 115, while transiting turn lane 205 to arrive at the offloading position Offₓ, would become blocked behind the other vehicle that is entering, or will enter, the turn lane 205.

If turn lane 205 is blocked (YES—block 1415), then device(s) 140 and/or device(s) 145 instructs the autonomous vehicle 115 to proceed to the empty or emptying offloading position Offₓ via thru lane 210 (block 1420). To instruct the vehicle 115, device(s) 140 and/or device(s) 145 may send a message to vehicle 115, via network(s) 125 and one or more of wireless stations 130, where the message includes instructions to change lanes from turn lane 205 to thru lane 210 (i.e., without colliding with any other vehicles 115), and continue to the previously instructed offloading position Offₓ. If turn lane 205 is determined to not be blocked (NO—block 1415), then the process may skip block 1420 and continue at block 1425.

Device(s) 140 and/or device(s) 145 determines if the vehicle 115 has completely offloaded (block 1425). Device(s) 140 and/or device(s) 145 may determine if the vehicle 115, once arrived at the first offloading position Offₓ, has completely offloaded as described with respect to FIGS. 11A and 11B above. The vehicle 115 can be determined to be completely offloaded when the offloaded status field 515 of an entry 500 that corresponds to the vehicle 115 indicates that the vehicle 115 has offloaded. If the vehicle 115 has not completely offloaded (NO—block 1425), then block 1425 may repeat until the vehicle is completely offloaded. If the vehicle 115 has completely offloaded (YES—block 1425), then device(s) 140 and/or device(s) 145 determines if another vehicle 115 in turn lane 205 and/or thru lane 210, is/are approaching position Posₓ (block 1465). Referring to the example of FIG. 8, if the autonomous vehicle 115 is offloading, for example, at offloading position Off₃, then device(s) 140 and/or device(s) 145 determines whether another vehicle(s) 115 is approaching position Pos₃ via either turn lane 205 or thru lane 210. If the other vehicle(s) 115 is/are determined to be approaching position Pos₃, then the vehicle(s) 115 may collide with the offloaded vehicle 115 if the vehicle 115 attempts to exit the offloading position Off₃ and turn into turn lane 205 or thru lane 210. Therefore, the other approaching vehicle(s) 115 in turn lane 205 or thru lane 210 may be instructed to temporarily halt at position Pos₃ to enable the offloaded vehicle 115 to turn out of the offloading position Off₃, and transit the offloading area 100 via the thru lane 210.

If no other autonomous vehicle 115 is approaching position Posₓ in turn lane 205 and/or thru lane 210 (NO—block 1470), then the exemplary process may skip block 1475 and continue at block 1480. If another vehicle 115 is approaching position Posₓ in turn lane 205 and/or thru lane 210 (YES—block 1470), then device(s) 140 and/or device(s) 145 instructs the other vehicle(s) 115 in turn lane 205 and/or the thru lane 210 to temporarily halt at position Posₓ (block 1475). Device(s) 140 and/or device(s) 145 sends a message to the vehicle(s) approaching position Posₓ, via network(s) 125 and one or more wireless stations 130, where the message instructs the vehicle(s) to temporarily halt at position Posₓ to enable the offloaded vehicle at offloading position Offₓ to depart the offloading pull-off area 200 and exit via thru lane 210. Device(s) 140 and/or 145 then instructs the autonomous vehicle 115 to depart the offloading position Offₓ and proceed to parking facility 105 (or to another destination) via the thru lane 210 (block 1480), and, once vehicle 115 has departed offloading position Offₓ and entered thru lane 210, instructs any temporarily halted vehicle(s) 115 at Posₓ, within turn lane 205 or thru lane 210, to resume movement to its instructed destination (block 1485). Device(s) 140 and/or 145 sends a message via network(s) 125 and at least one wireless station 130 that instructs the autonomous vehicle 115 to depart the offloading position Offₓ and proceed to parking facility 105 or to another destination. In a circumstance where the autonomous vehicle 115 is not parking in the parking facility 105, but is instead departing the area to proceed to another location (e.g., to a location associated with a ride sharing entity in a situation where the passenger(s) do not own, or are not retaining control over, the vehicle), then the message sent by device(s) 140 and/or 145 may instruct the autonomous vehicle 115 to proceed to a departure point from the property that includes passenger offloading area 100 and parking facility 105. Once the vehicle 115 reaches the departure point, device(s) 140 and/or 145 relinquish control over the vehicle 115, and vehicle 115 then autonomously drives to the other location.

Returning to block 1405, if there are no offloading positions Offₓ that are determined to not have a vehicle 115 proceeding to them, and are either empty or have a current occupying vehicle that is moving out of the offloading position (NO—block 1405), then device(s) 140 and/or 145 determines an offloading position Offₓ, having a currently offloading vehicle with a highest probability of emptying within the next z seconds (block 1430)(FIG. 14B). The amount of z seconds may be a configurable time value that may be specified by a system administrator, or which may be continually adjusted based on an algorithm. For each of the vehicles 115 currently offloading at a respective offloading position Offₓ, device(s) 140 retrieves a corresponding offloading time t_{Offx}, from a field 520 of an entry 500 for each vehicle 115, where the offloading time ton represents an elapsed amount of time that the particular vehicle 115 has been currently offloading at the respective offloading position Offₓ.

Referring to FIG. 13C, and the previous description of FIG. 13C above, device(s) 140 determines a probability of offloading of each vehicle 115 currently offloading by setting t₁ equal to zero, and t₂ equal to the sum of the current offloading time t_{Offx} for each currently offloading vehicle 115 and z, and calculating the probability of offload (Pr_{Offload}) as equal to the area under the relative frequency distribution curve over the interval t₁=0 to t₂=t_{Offx}+z. Therefore, for each vehicle 115 currently offloading at an offloading position Offₓ, device(s) 140 retrieves a current offloading time t_{Offx} from field 520 of an entry 500 of DB 150 that has a vehicle ID stored in field 505 that matches the vehicle ID of the currently offloading vehicle 115. Device(s) 140 adds the configurable time period z to each retrieved current offloading time t_{Offx}, and, based on the relative frequency distribution curve, determines which currently offloading vehicle 115 has the highest probability (Pr_{Offload}) of offloading within the next z seconds.

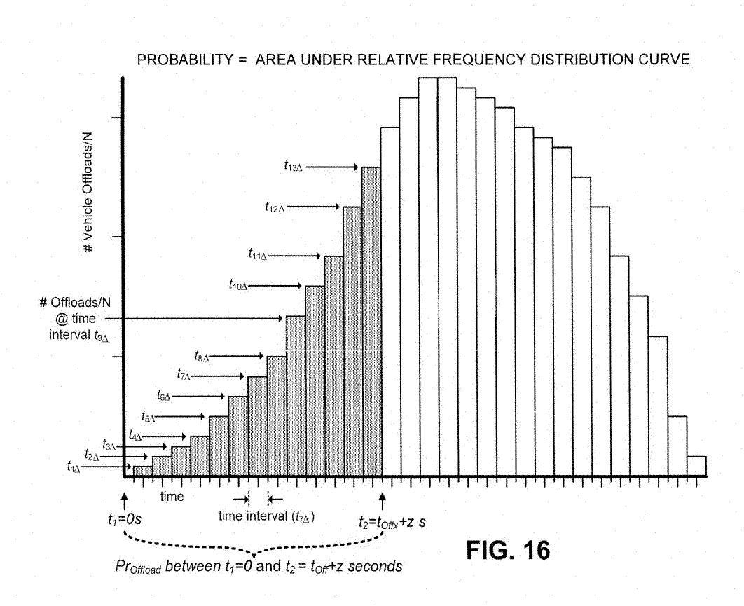

FIG. 16 depicts an example relative frequency distribution curve for purposes of illustrating the calculation of the probability of offloading for vehicles at offloading positions Offₓ in block 1430. In the example of FIG. 16, a probability for each currently offloading vehicle 115 can be determined, based on the relative frequency distribution curve, for the interval spanning t₁=0 seconds to t₂=t_{Offx}+z seconds. As shown in FIG. 16, the time interval spanning t₁ seconds to t₂ seconds includes 13 different timing bin intervals t_{1Δ}, t_{2Δ}, t_{3Δ}, t_{4Δ}, t_{5Δ}, t_{6Δ}, t_{7Δ}, t_{8Δ}, t_{9Δ}, t_{10Δ}, t_{11Δ}, t_{12Δ}, and t_{13 Δ} (shown highlighted). By multiplying the # Offloads/N at each timing bin interval t_{Δ} by the length of the timing bin interval tΔ, and adding all of these values together, the probability of offload (Pr_{Offload}) the interval for time interval spanning t₁ to t₂ seconds for the currently offloading vehicle 115 may be determined. Therefore, as shown in the example of FIG. 16, Pr_{Offload}, between t₁=0 seconds to t₂=t_{Offx}+z seconds, for a particular vehicle 115 offloading at an offloading position Offₓ, equals (# Offloads/N @time interval t_{1Δ}*t_{1Δ})+(# Offloads/N @time interval t_{2Δ}*t_{2Δ})+(# Offloads/N @time interval t_{3Δ}*t_{3Δ})+(# Offloads/N @time interval t_{4Δ}*t_{4Δ})+(# Offloads/N @time interval t_{5Δ}*t_{5Δ})+(# Offloads/N @time interval t_{6Δ}*t_{6Δ}) Offloads/N @time interval t_{7Δ}*t_{7Δ}), (# Offloads/N @time interval t_{8Δ}*t_{8Δ})+(# Offloads/N @time interval t_{9Δ}*t_{9Δ})+(# Offloads/N @time interval t_{10Δ}*t_{10Δ})+(# Offloads/N @time interval t_{11Δ}*t_{11Δ})+(# Offloads/N @time interval t_{12Δ}*t_{12Δ})+(# Offloads/N @time interval t_{13Δ}*t_{13Δ}). The determined probabilities Pr_{Offload} for all of the currently offloading vehicles 115 may be compared to identify the vehicle 115 (and corresponding offloading position Offₓ) having the highest probability of completing offloading within the next z seconds.

Device(s) 140 and/or 145 sends the autonomous vehicle 115 to position Posₓ₋₁ via turn lane 205 (block 1435). If offloading position Offₓ (where x is any integer within 1 to x) is the offloading position determined to have the highest probability (Pr_{Offload}) of completing the offloading process in block 1430, then position Posₓ₋₁ would be the position along turn lane 205 that is just prior to the offloading position Offₓ. For example, referring to FIG. 8, if offloading position Off₃ is determined to have a vehicle 115 that has the highest probably of completing the offloading process, then device(s) 140 and/or 145 sends the autonomous vehicle 115 to Pos₂ to wait for offloading position Off₃ to empty. Device(s) 140 and/or device(s) 145 sends a message to the autonomous vehicle 115 at position Pos₀ via network(s) 125 and one or more wireless stations 130, where the message instructs the vehicle(s) 115 to drive to position Posₓ₋₁ via turn lane 205.

Device(s) 140 and/or 145 determines if the turn lane 205 is blocked for the autonomous vehicle 115 sent to position Posₓ₋₁ in block 1435 (block 1440). The turn lane 205 is blocked if device(s) 140 and/or device(s) 145 determines that another vehicle 115 is currently located in turn lane 205, or is heading into turn lane 205, and obstructs, or will obstruct, the current vehicle 115's path to position Posₓ₋₁. Another vehicle 115 may obstruct turn lane 205, for example, by being temporarily halted at any queuing position Posₓ within turn lane 205 such that the vehicle 115, while transiting turn lane 205 to arrive at the position Posₓ₋₁ would become blocked behind the other temporarily halted vehicle 115. Additionally, another vehicle 115 may obstruct turn lane 205, if device(s) 140 and/or device(s) 145 has instructed another vehicle 115 to enter turn lane 205 in front of the current vehicle 115 such that the current vehicle 115, while transiting turn lane 205 to arrive at the position Posₓ₋₁, would become blocked behind the other vehicle that is entering, or will enter, the turn lane 205. If the turn lane 205 is not blocked (NO—block 1440), then the exemplary process skips block 1445 and continues at block 1450 below.

If the turn lane 205 is blocked (YES—block 1440), then device(s) 140 and/or 145 instructs the autonomous vehicle 115 to proceed to position Posₓ₋₁ via thru lane 210 (block 1445). Device(s) 140 and/or device(s) 145 sends a message to the autonomous vehicle 115, that has been sent to position Posₓ₋₁, via network(s) 125 and one or more wireless stations 130, where the message instructs the vehicle(s) 115 to switch lanes from turn lane 205 to thru lane 210 and continue driving to position Posₓ₋₁.

Once vehicle 115 has reached position Posₓ₋₁, device(s) 140 and/or 145 determines if the offloading position Offₓ, to which the vehicle 115 was sent in block 1435, is currently empty of any other vehicle 115 (block 1450). For example, referring to FIG. 8, if the vehicle 115 has been instructed to proceed to offloading position Off₃, and has reached queuing position Pos₂, then device(s) 140 and/or 145 determines if offloading position Off₃ is currently empty of any other vehicle 115.

If offloading position Offₓ is currently not yet empty (NO—block 1450), then block 1450 repeats, holding the vehicle 115 at position Posₓ₋₁, until offloading position Offₓ becomes empty (i.e., the other occupying vehicle 115 departs). If offloading position Offₓ is empty (YES—block 1450), then device(s) 140 and/or 145 sends the autonomous vehicle 115 from position Posₓ₋₁ to the offloading position Offₓ (block 1455). Device(s) 140 and/or device(s) 145 sends a message to the autonomous vehicle 115, waiting at queuing position Posₓ₋₁, via network(s) 125 and one or more wireless stations 130, where the message instructs the vehicle(s) 115 to drive from position Posₓ₋₁ to the offloading position Offₓ. Employing known autonomous driving techniques, vehicle 115 would, of course, avoid colliding with, or dangerously cutting off, any other vehicle transiting turn lane 205 as the vehicle 115 proceeds from Posₓ₋₁, across turn lane 205, and into offloading position Offₓ.

Device(s) 140 and/or 145 determines if the autonomous vehicle 115 has completely offloaded once the vehicle 115 reaches the offloading position Offₓ and has temporarily parked (block 1460). Device(s) 140 and/or device(s) 145 may determine if the vehicle 115 has completely offloaded as described with respect to FIGS. 11A and 11B above. The vehicle 115 can be determined to be completely offloaded when the offloaded status field 515 of an entry 500 that corresponds to the vehicle 115 indicates that the vehicle 115 has offloaded. If vehicle 115 has not completed offloading (NO—block 1460), then block 1460 repeats. If autonomous vehicle 115 has been completely offloaded (YES—block 1460), then the exemplary process continues at block 1465, FIG. 14C (see above).

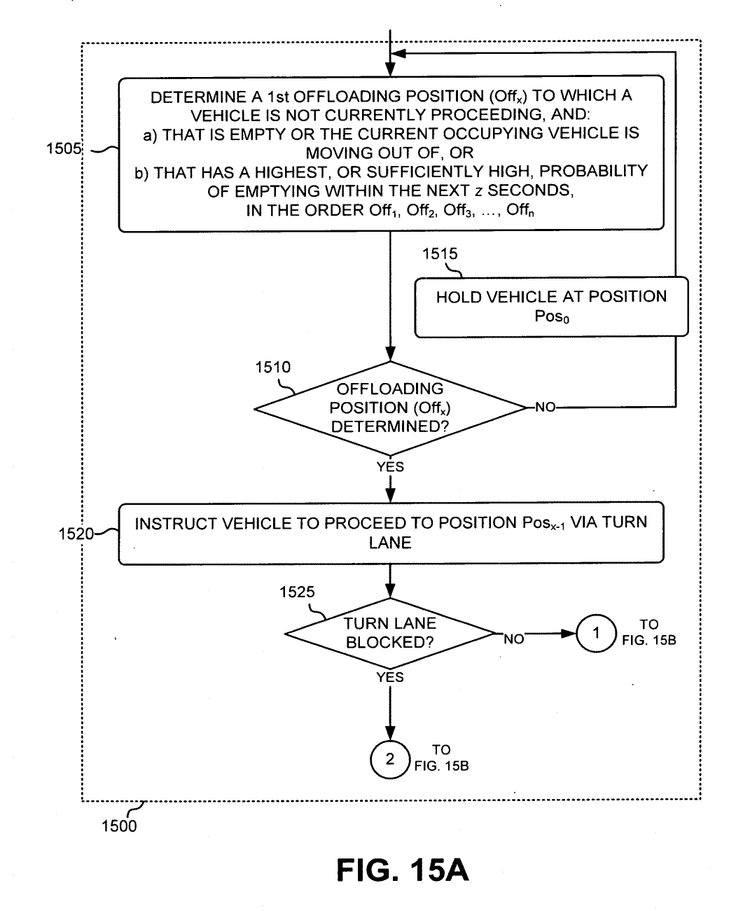

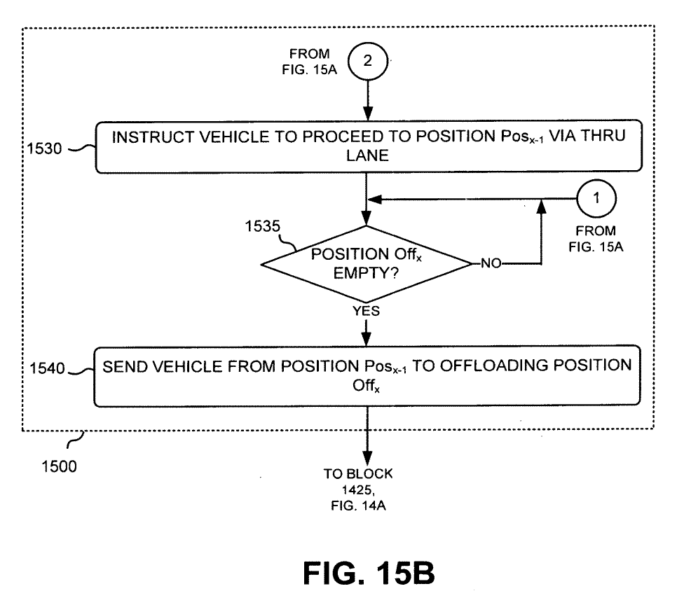

Blocks 1500, depicted in FIGS. 15A and 15B, may be optionally executed in place of the blocks identified at 1413 in FIG. 14A (e.g., in place of blocks 1400, 1405, 1410, 1415, and 1420). Optional blocks 1500 use probability values, determined such as described with respect to FIGS. 13A-13C, and FIG. 16 above, for determining a first offloading position that is predicted to have a vehicle 115 with the highest probability of completing passenger offloading, or a sufficiently high probability of completing passenger offloading, within a particular period of time. When the autonomous vehicle 115 arrives at an entry position Pos₀ of passenger offloading area 100, device(s) 140 and/or device(s) 145 determine a first offloading position (Offₓ) to which another vehicle 115 is currently not proceeding, and:

a) that is empty or the current occupying vehicle 115 is moving out of, or

b) that has a highest, or sufficiently high, probability of emptying within the next z seconds,

in the order of Off₁, Off₂, Off₃, . . . , Offₙ (closest to farthest) (block 1505).

Device(s) 140 and/or device(s) 145 analyzes an image(s)/video from cameras 135, using image/video recognition techniques, to determine the closest offloading position Offₓ, of offloading positions Off₁, Off₂, Off₃, . . . , Offₙ, to the first queuing position Pos₀ that is currently empty of vehicles 115, or which the current occupying vehicle 115 is moving out of. The amount of z seconds may be a configurable time value that may be specified by a system administrator, or which may be continually adjusted based on an algorithm. For each of the vehicles 115 currently offloading at an offloading position Offₓ, device(s) 140 retrieves a corresponding offloading time t_{Offx}, from a field 520 of an entry 500 for each vehicle 115, where the offloading time t_{Offx} represents an elapsed amount of time that the particular vehicle 115 has been currently offloading at the respective offloading position Offₓ.

Referring again to FIG. 13C, and the previous description of FIG. 13C above, device(s) 140 determines a probability of offloading of each vehicle 115 currently offloading by setting t₁ equal to zero, and t₂ equal to the sum of the current offloading time t_{Offx} for each currently offloading vehicle 115 and z, and calculating the probability of offload (Pr_{Offload}) as equal to the area under the relative frequency distribution curve over the interval t₁=0 to t₂=t_{Offx}+z. Therefore, for each vehicle 115 currently offloading at an offloading position Off within passenger offloading area 100, device(s) 140 retrieves a current offloading time t_{Offx} from field 520 of an entry 500 of DB 150 that has a vehicle ID stored in field 505 that matches the vehicle ID of the currently offloading vehicle 115. Device(s) 140 adds the configurable time period z to each retrieved current offloading time t_{Offx}, and, based on the relative frequency distribution curve, determines which currently offloading vehicle 115 has the highest probability (Pr_{Offload}) of offloading, or a sufficiently high probability of offloading, within the next z seconds.

Referring again to the illustrative example of FIG. 16, a probability for each currently offloading vehicle 115 can be determined, based on the relative frequency distribution curve, for the interval spanning t₁=0 seconds to t₂=t_{Offx}+z seconds. As shown in FIG. 16, the time interval spanning t₁ seconds to t₂ seconds includes 13 different timing bin intervals t_{1Δ}, t_{2Δ}, t_{3Δ}, t_{4Δ}, t_{5Δ}, t_{6Δ}, t_{7Δ}, t_{8Δ}, t_{9Δ}, t_{10Δ}, t_{11Δ}, t_{12Δ}, and t_{13Δ} (shown highlighted). By multiplying the # Offloads/N at each timing bin interval t_{Δ} by the length of the timing bin interval t_{Δ}, and adding all of these values together, the probability of offload (Pr_{Offload}) for the time interval spanning t₁ to t₂ seconds for the currently offloading vehicle 115 may be determined. Therefore, as shown in the example of FIG. 16, Pr_{Offload}, between t₁=0 seconds to t₂=t_{Offx}+z seconds, for a particular vehicle 115 offloading at an offloading position Offₓ, equals (# Offloads/N @time interval t_{1Δ}*t_{1Δ})+(# Offloads/N @time interval t_{2Δ}*t_{2Δ})+(# Offloads/N @time interval t_{3Δ}*t_{3Δ})+(# Offloads/N @time interval t_{4Δ}*t_{4Δ})+(# Offloads/N @time interval t_{5Δ}*t_{5Δ})+(# Offloads/N @time interval t_{6Δ}*t_{6Δ})+(# Offloads/N @time interval t_{7Δ}*t_{7Δ}), (# Offloads/N @time interval t_{8Δ}*t_{8Δ})+(# Offloads/N @time interval t_{9Δ}*t_{9Δ})+(# Offloads/N @time interval t_{10Δ}*t_{10Δ})+(# Offloads/N @time interval t_{11Δ}*t_{11Δ})+(# Offloads/N @time interval t_{12Δ}*t_{12Δ})+(# Offloads/N @time interval t_{13Δ}*t_{13Δ}). The determined probabilities Pr_{Offload} for all of the currently offloading vehicles 115 may be compared with one another to identify the vehicle 115 (and corresponding offloading position Offₓ) having the highest probability, or a sufficiently high probability (e.g. greater than 0.75 probability), of completing offloading within the next z seconds. In some implementations, a weighting algorithm may be employed, that weights the closeness of the offloading position Offₓ, and the determined probability of the vehicle 115 completing the offloading at that position Offₓ within the next z seconds, to determine which offloading position Offₓ to which a vehicle 115 at the entrance 110 to passenger offloading area 110 should be directed to drive to.

Device(s) 140 and/or device(s) 145 determine if an offloading position Offₓ is determined in block 1505 (block 1510). For example, if offloading positions Off₄ and Off₈ are currently empty, and no other vehicles 115 are currently proceeding to those offloading positions, then offloading position Off₄, being the closest to queuing position Pos₀, is selected as the offloading position to which the vehicle 115 at position Pos₀ is sent for offloading. As another example, if vehicles 115 are currently moving out of offloading positions Off₈ and Off₉, and no other vehicles 115 are currently proceeding to those offloading positions, then offloading position Off₅, being the closest to queuing position Pos₀, is selected as the offloading position to which the vehicle at position Pos₀ is sent for offloading. As a further example, a threshold probability of Pr_{Offload} is set at 0.75 (other threshold levels may, alternatively, be set), and it is determined that vehicles 115 at Off₁ and Off₃ each are predicted to have a probability of at least 0.75 of completing the offload process within the next z seconds. Though Off₁ is closest to the entrance 100, the vehicle 115 being offloaded at Off₁ has a probability Pr_{Offload} of 0.75 whereas the vehicle 115 being offloaded at Off₃ has a probability Pr_{Offload} of 0.95. Therefore, offloading position Off₃ is selected as having a sufficiently high probability of offloading, relative to the other offloading positions, and the vehicle 115 currently at the entrance 110 to passenger offloading area 100 is instructed to proceed to offloading position Off₃ via turn lane 205.

If an offloading position Offₓ has not been determined (NO—block 1510), then device(s) 140 and/or device(s) 145 holds the vehicle 115 at position Pos₀ (block 1515), and the process returns to block 1505 to repeat the determination of block 1505. No offloading position Offₓ may be determined in block 1505 if, for example, each offloading position Offₓ is currently occupied with a vehicle, another vehicle 115 is currently proceeding to that offloading position, or the probability(ies) of a currently offloading vehicle(s) completing offloading within an offloading position(s) is/are sufficiently low, such that no offloading positions are considered by device(s) 140 and/or device(s) 145 to be available for sending the current vehicle 115 to.

If an offloading position Offₓ has been determined in block 1505 (YES—block 1510), then device(s) 140 and/or device(s) 145 instructs the vehicle 115 to proceed to position Posₓ₋₁ via turn lane 205 (block 1520). Device(s) 140 and/or device(s) 145 sends a message to the autonomous vehicle 115; at position Pos₀, via network(s) 125 and one or more wireless stations 130, where the message instructs the vehicle(s) 115 to drive from position Pos₀ to position Posₓ₋₁.

Device(s) 140 and/or device(s) 145 determines if the turn lane 205 is blocked by another vehicle 115 (block 1525). The turn lane 205 is blocked if device(s) 140 and/or device(s) 145 determines that another vehicle 115 is currently located in turn lane 205, or is heading into turn lane 205, and obstructs, or will obstruct, the current vehicle 115's path to position Posₓ₋₁. Another vehicle 115 may obstruct turn lane 205, for example, by being temporarily halted at a queuing position Posₓ within turn lane 205 such that the vehicle 115, while transiting turn lane 205 to arrive at the position Posₓ₋₁ would become blocked behind the other temporarily halted vehicle 115. Additionally, another vehicle 115 may obstruct turn lane 205, if device(s) 140 and/or device(s) 145 has instructed another vehicle 115 to enter turn lane 205 in front of the current vehicle 115 such that the current vehicle 115, while transiting turn lane 205 to arrive at the position Posₓ₋₁, would become blocked behind the other vehicle that is entering, or will enter, the turn lane 205.

If the turn lane 205 is blocked (YES—block 1525), then device(s) 140 or device(s) 145 instructs the vehicle 115 to proceed to position Posₓ₋₁ via thru lane 210 (block 1530). Device(s) 140 and/or device(s) 145 sends a message to the autonomous vehicle 115, that has been sent to position Posₓ₋₁, via network(s) 125 and one or more wireless stations 130, where the message instructs the vehicle(s) 115 to safely witch lanes from turn lane 205 to thru lane 210 and continue driving to position Posₓ₋₁. If the turn lane 205 is not blocked (NO—block 1525), then the exemplary process continues at block 1535 below.

Once vehicle 115 has reached position Posₓ₋₁, device(s) 140 and/or 145 determines if the offloading position Offₓ, to which the vehicle 115 was sent in block 1520, is currently empty of any other vehicle 115 (block 1535). For example, referring to FIG. 8, if the vehicle 115 has been instructed to proceed to offloading position Off₃, and has reached position Pos₂, then device(s) 140 and/or 145 determines if offloading position Off₃ is currently empty of any other vehicle 115.

If the offloading position Offₓ is currently not yet empty (NO—block 1535), then block 1535 repeats, holding the vehicle 115 at position Posₓ₋₁, until offloading position Offₓ becomes empty (i.e., the other occupying vehicle 115 departs). If offloading position Offₓ is empty (YES—block 1535), then device(s) 140 and/or 145 sends the autonomous vehicle 115 from position Posₓ₋₁ to the offloading position Offₓ (block 1540). Device(s) 140 and/or device(s) 145 sends a message to the autonomous vehicle 115, waiting at position Posₓ₋₁, via network(s) 125 and one or more wireless stations 130, where the message instructs the vehicle(s) 115 to drive from position Posₓ₋₁ to the offloading position Offₓ. Employing known autonomous driving techniques, vehicle 115 would, of course, avoid colliding with, or dangerously cutting off, any other vehicle transiting turn lane 205 as the vehicle 115 proceeds from Posₓ₋₁, across turn lane 205, and into offloading position Offₓ. Subsequent to block 1540 of optional blocks 1500, the exemplary process continues at block 1425 of FIG. 14A.

The foregoing description of implementations provides illustration and description, but is not intended to be exhaustive or to limit the invention to the precise form disclosed. Modifications and variations are possible in light of the above teachings or may be acquired from practice of the invention. For example, while series of blocks have been described with respect to FIGS. 6, 10, 11A, 11B, 14A-14C, 15A, and 15B, the order of the blocks may be varied in other implementations. Moreover, non-dependent blocks may be performed in parallel. Embodiments have been described herein with respect to the offloading of passengers within a passenger offloading area. However, the passenger offloading area described herein, and the associated system for coordinating the movement of autonomous vehicles 115 within the passenger offloading area, may be also applied to the pickup of passengers. The passenger offloading area described herein may be used as a passenger pickup area, and autonomous vehicles 115 arriving from parking facility 105, or from other locations, may be controlled by the system described herein to coordinate the movement of the vehicles 115 through the passenger pickup area to enable passengers to load into their respective autonomous vehicles for departure.

Certain features described above may be implemented as “logic” or a “unit” that performs one or more functions. This logic or unit may include hardware, such as one or more processors, microprocessors, application specific integrated circuits, or field programmable gate arrays, software, or a combination of hardware and software.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise. As used herein, “exemplary” means “serving as an example, instance or illustration.”

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A system, comprising:
a plurality of cameras directed to capture images or video of a passenger offloading area associated with a facility, wherein the passenger offloading area comprises a plurality of offloading areas that enable a plurality of autonomous vehicles to offload vehicle occupants or passengers, and then exit the passenger offloading area;
at least one device, coupled to the plurality of cameras and to at least one wireless station, and configured to:
receive images or video, from the plurality of cameras, of a plurality of portions of the passenger offloading area, including each of the plurality of offloading areas,
analyze the images or video to identify autonomous vehicles of the plurality of autonomous vehicles that have completed passenger offloading and have departed respective offloading areas of the plurality of offloading areas,
instruct, via the at least one wireless station based on the image or video analysis, the plurality of autonomous vehicles to transit through the passenger offloading area in a coordinated manner, including stopping at a selected one of the plurality of passenger offloading areas, to offload the vehicle occupants or passengers, and
instruct, via the at least one wireless station, each of the plurality of autonomous vehicles to drive to a destination outside of the passenger offloading area subsequent to transiting through the passenger offloading area.

2. The system of claim 1, wherein the passenger offloading area further comprises a first lane of traffic, and a second lane of traffic that runs parallel to the first lane, and wherein the plurality of offloading areas are spaced along the first lane to enable the plurality of autonomous vehicles to pull off the first lane or the second lane into the plurality of offloading areas, offload passengers, and then exit the passenger offloading area via the first lane or the second lane.

3. The system of claim 1, wherein the facility comprises an activity, event, entity, or building where numerous employees, guests, invitees, or licensees can offload from the plurality of autonomous vehicles in an efficient and safe manner.

4. The system of claim 1, wherein, when instructing the plurality of autonomous vehicles to transit through the passenger offloading area in the coordinated manner, the at least one device is configured to:
maximize the flow of the plurality of autonomous vehicles through the passenger offloading area,
minimize a waiting time of passengers within the plurality of autonomous vehicles that are waiting to offload from their respective vehicles, and
maximize the safety of autonomous vehicles, passengers, and pedestrians within the passenger offloading area.

5. The system of claim 1, wherein the at least one device is further configured to:
send, via the at least one wireless station prior to instructing the plurality of autonomous vehicles to transit through the passenger offloading area in a coordinated manner, a request to each of the plurality of autonomous vehicles requesting control of the plurality of autonomous vehicles by the at least one device, wherein the request is presented to at least one occupant in each of the plurality of autonomous vehicles, and
receive a reply message, via the at least one wireless station from each of the plurality of autonomous vehicles, granting control, or denying control to the at least one device, wherein the reply is based on input provided by the at least one occupant in each of the plurality of autonomous vehicles.

6. The system of claim 1, wherein the plurality of cameras and the at least one device are coupled to one or more networks, and further comprising:
a plurality of offloading stations, with each of the plurality of offloading stations being located in proximity to a respective one of the plurality of offloading pull-off areas, wherein the plurality of offloading stations couple to the one or more networks and wherein each of the plurality of offloading stations is configured to:
receive manual input that indicates that passenger offloading of one or more first autonomous vehicles of the plurality of autonomous vehicles has completed and that the one or more first autonomous vehicles are ready to be sent out of the passenger offloading area, and
send, via the one or more networks, messages that identify the one or more first autonomous vehicles as offloaded autonomous vehicles that have completed the passenger offloading and further identify a respective offloading pull-off area of the plurality of offloading pull-off areas from which the offloaded autonomous vehicles has subsequently departed or is departing.

7. The system of claim 6, wherein the plurality of offloading stations are located at fixed locations in proximity to respective ones of the plurality of offloading pull-off areas, and wherein the plurality of offloading stations, when receiving manual input that indicates that the passenger offloading of the one or more first autonomous vehicles of the plurality of autonomous vehicles has completed, are further configured to:
receive input from occupants of the one or more first autonomous vehicles that is manually entered into the plurality of offloading stations located at the fixed locations.

8. The system of claim 6, wherein the plurality of offloading stations each comprise hand-held portable devices carried in proximity to respective ones of the offloading pull-off areas, and wherein the plurality of offloading stations, when receiving manual input that indicates that the passenger offloading of the one or more first autonomous vehicles of the plurality of autonomous vehicles has completed, are further configured to:
receive input from a plurality of attendants that witness the passenger offloading of the one or more first autonomous vehicles that is manually entered into a respective one of the hand-held portable devices.

9. The system of claim 1, wherein the at least one device is further configured to:
determine offloading times associated with the offloading of passengers from previously offloaded autonomous vehicles of the plurality of autonomous vehicles within the passenger offloading area;
determine a relative frequency distribution based on the determined offloading times; and
determine a respective one of the offloading pull-off areas to send subsequent autonomous vehicles of the plurality of autonomous vehicles to for passenger offloading based on the determined relative frequency distribution.

10. The system of claim 1, wherein the at least one device is further configured to:
determine, based, at least in part, on the image or video analysis, a respective one of the offloading pull-off areas to send each of one or more second autonomous vehicles of the plurality of autonomous vehicles to for passenger offloading,
wherein the determining is based on the one of the passenger offloading pull-off areas that has a highest, or a sufficiently high, probability, based on a relative frequency distribution analysis, that a currently offloading vehicle will depart the one of the passenger offloading pull-off areas within a next number of seconds.

11. The system of claim 1, wherein the second lane of traffic runs adjacent to, and parallel with, the first lane of traffic, and opposite to the offloading pull-off areas, wherein the first lane of traffic permits direct turns into, and out of, the offloading pull-off areas and wherein the second lane of traffic permits thru traffic of the plurality of autonomous vehicles to transit from one end of the passenger offloading area to another end of the passenger offloading area, and wherein the at least one device, when instructing the plurality of autonomous vehicles to transit through the passenger offloading area in the coordinated manner, is further configured to:
instruct, based, at least in part, on the image or video analysis, the plurality of autonomous vehicles to transit through the passenger offloading area, via the first lane or the second lane in the coordinated manner, including stopping at the one of the plurality of passenger offloading pull-off areas, to offload passengers during transit of the passenger offloading area.

12. The system of claim 1, further comprising:
the at least one wireless station, wherein the at least one wireless station is located in proximity to the passenger offloading area to provide wireless coverage for wirelessly connecting to the plurality of autonomous vehicles within the passenger offloading area, wherein the at least one wireless station further couples to the one or more networks, and
wherein the at least one device is coupled to the at least one wireless station via the one or more networks.

13. The system of claim 12, wherein the at least one wireless station comprises a plurality of wireless stations distributed throughout the passenger offloading area to provide wireless coverage for wirelessly coupling the plurality of autonomous vehicles within the passenger offloading area to the one or more networks.

14. A method, comprising:
designating, by a first device, a plurality of queuing positions and a plurality of passenger offloading positions within a passenger offloading area associated with a facility, wherein the passenger offloading area comprises a first lane of traffic and a plurality of areas along the first lane that enable autonomous vehicles to pull off the first lane into the plurality of areas, offload passengers at the plurality of passenger offloading positions, and then return to the first lane;
receiving, by the first device, images or video from a plurality of cameras that are positioned to capture images or video of a plurality of portions of the passenger offloading area, including each of the passenger offloading positions;
analyzing, by the first device, the images or video using image recognition techniques;
instructing, by the first device based on the image or video analysis, a plurality of autonomous vehicles to transit through the passenger offloading area in a coordinated manner, including through each of the plurality of queuing positions and stopping at one of the passenger offloading positions, to offload passengers from the plurality of autonomous vehicles; and
instructing, by the first device, each of the plurality of autonomous vehicles to drive to a destination outside of the passenger offloading area subsequent to transiting through each of the plurality of queuing positions and stopping at the one of the passenger offloading positions to offload passengers.

15. The method of claim 14, further comprising:
receiving manual input, from one of the passengers or an attendant, that identifies when a respective one of the plurality of autonomous vehicles has been offloaded of passengers, and
wherein instructing the plurality of autonomous vehicles to transit through the passenger offloading area is further based on the received manual input.

16. The method of claim 11, further comprising:
determining offloading times associated with offloading of passengers from previous autonomous vehicles within the passenger offloading area;
determining a relative frequency distribution based on the determined offloading times; and
determining a respective one of the passenger offloading positions to send each of the plurality of autonomous vehicles to for passenger offloading based on the determined relative frequency distribution.

17. The method of claim 11, further comprising:
determining, based on the image or video analysis, a respective one of the passenger offloading positions to send each of the plurality of autonomous vehicles to for passenger offloading, wherein the determining is based on the one of the passenger offloading positions that has a highest probability or a sufficiently high probability, based on a relative frequency distribution analysis, that a currently offloading vehicle will depart the one of the passenger offloading positions within a next number of seconds.

18. A non-transitory storage medium storing instructions executable by a device, wherein the instructions comprise instructions to cause the device to:
determine the locations and movement status of a plurality of autonomous vehicles within a passenger offloading area associated with a facility, comprising a plurality of offloading pull-off areas, based on geolocation data associated with the plurality of autonomous vehicles or based on image analysis of images or video from a plurality of cameras directed towards the passenger offloading area;
determine offloading times associated with offloading of passengers from previously offloaded autonomous vehicles of the plurality of autonomous vehicles within the passenger offloading area;
determine a relative frequency distribution based on the determined offloading times;
determining a respective one of the plurality of offloading pull-off areas to send each subsequent autonomous vehicle of the plurality of autonomous vehicles to for passenger offloading based on the determined relative frequency distribution.

19. The non-transitory storage medium of claim 18, wherein the instructions to cause the device to determine a respective one of the plurality of offloading pull-off areas to send the subsequent autonomous vehicles to for passenger offloading further comprise instructions to cause the device to:
determine probabilities, based on the determined relative frequency distribution, that currently offloading autonomous vehicles will finish offloading and depart the passenger offloading area within a next number of seconds;
instruct each of the subsequent autonomous vehicles to proceed to a selected one of the plurality of offloading pull-off areas based on the determined probabilities.

20. The non-transitory storage medium of claim 19, wherein the instructions to cause the device to determine a respective one of the plurality of offloading pull-off areas to send the subsequent autonomous vehicles to for passenger offloading further comprise instructions to cause the device to:
select the one of the plurality of offloading pull-off areas that has a highest probability of the determined probabilities, or a sufficiently high probability, that a respective one of the currently offloading autonomous vehicles will finish offloading and depart the one of the plurality of offloading pull-off areas within the next number of seconds.
